(19) United States
(12) Patent Application Publication
(10) Pub. No.: US 2025/0137221 A1
(43) Pub. Date: May 1, 2025

(54) ADHESION SUPPRESSING MEMBER, WORK TOOL, CLAW MEMBER, AND ADHESION SUPPRESSING METHOD

(71) Applicants: OBAYASHI CORPORATION, Tokyo (JP); OBAYASHI ROAD CORPORATION, Tokyo (JP)

(72) Inventors: Yuki KASUYA, Kiyose-shi, Tokyo-to (JP); Reina HORII, Nerima-ku, Tokyo-to (JP); Toshimitsu KOBAYASHI, Toshima-ku, Tokyo-to (JP); Yukinobu KIMURA, Nishitokyo-shi, Tokyo-to (JP); Katsuji FUKUMOTO, Nagahama-shi, Shiga-ken (JP); Toshiaki KATO, Saitama-shi, Saitama-ken (JP); Syuuhei MITSUTANI, Saitama-shi, Saitama-ken (JP); Kiminori WASHIKA, Hiroshima-shi, Hiroshima-ken (JP); Tatsumi KAWAFUCHI, Hiroshima-shi, Hiroshima-ken (JP)

(73) Assignees: OBAYASHI CORPORATION, Tokyo (JP); OBAYASHI ROAD CORPORATION, Tokyo (JP)

(21) Appl. No.: 18/833,573

(22) PCT Filed: Mar. 22, 2024
(86) PCT No.: PCT/JP2024/011299

§ 371 Date: Jul. 26, 2024

(30) Foreign Application Priority Data
Apr. 25, 2023 (JP) 2023-071316
Nov. 27, 2023 (JP) 2023-199744

(51) Int. Cl. E02F 3/40; B08B 17/02; E21B 11/04

(52) U.S. Cl. CPC E02F 3/40; B08B 17/02; E21B 11/04

(57) ABSTRACT

Provided is an adhesion suppressing member that is configured to suppress a work piece from adhering to a work tool of a construction machinery. The adhesion suppressing member is formed in a plate shape and includes, on a front surface thereof, a resin material having a water repellent property. The adhesion suppressing member is installed at a predetermined portion of the work tool such that the front surface forms a part of a surface of the work tool held in contact with the work piece.

### TECHNICAL FIELD

The present disclosure relates to an adhesion suppressing member, a work tool, a claw member, and an adhesion suppressing method, and in particular, a technology suitable for a construction machinery that processes work pieces, such as soil and sand, mud, or the like.

### BACKGROUND ART

In soil work, ground improvement work, pile work, or the like, excavation work using a construction machinery, such as a backhoe, a wheel loader, an earth auger, an earth drill, a bulldozer, a horizontal multi-shaft excavator, or a power blender is performed. For example, in the case of the backhoe, when soil materials including clay containing water adhere to and deposit on an inner surface of a bucket during excavation work, the substantial capacity of the bucket decreases, which results in causing a decrease in work efficiency.

In such a case, an operator swings the bucket or applies an impact to the bucket to shake out adhesion residual soil from the inside of the bucket. However, there is a problem in that swing of the bucket or application of an impact thereto causes large noise or vibration, and hence construction in consideration of a surrounding environment has been demanded. Further, due to swing of the bucket or accumulation of an impact applied thereto, a connector for a bucket connecting portion or a bucket distal end portion is liable to fatigue, and hence a labor to perform replacement occurs.

The decrease in work efficiency due to the adhesion residual soil inside the bucket also occurs in an automatic driving system of a construction machinery that has been put in practical use in recent years. It is difficult that the system side sequentially grasps the adhesion residual soil inside the bucket during automatic driving, and further, it is also difficult to intentionally swing the bucket by automatic control. Thus, when automatic driving continues for a certain period time or more, the automatic driving is interrupted, and the inside of the bucket is to be cleaned. However, cleaning of the bucket requires a worker to approach the construction machinery. Thus, for example, the worker may touch another construction machinery during automatic driving, and hence there is a problem in that safety cannot be sufficiently secured.

A technology for preventing soil adhesion inside a bucket is disclosed in, for example, Patent Literature 1. In the technology described in Patent Literature 1, a coating film having a water repellent property or a lining body is provided on the entire inner surface of the bucket.

### CITATION LIST

### Patent Literature

[PTL 1] JP 2001-164595 A

### SUMMARY OF INVENTION

### Technical Problem

Incidentally, the bucket includes a curved portion, a bead portion formed by welding, and the like. Thus, it is substantially difficult to perform mounting processing such that the lining body or the coating film is held in close contact with the entire inner surface of the bucket as in the technology described in Patent Literature 1. Further, in the configuration in which the lining body or the coating film is provided on the entire inner surface of the bucket, it is difficult to partially repair only a broken portion when the lining body or the coating film is broken due to an impact or the like at the time of excavation. Thus, in the technology described in Patent Literature 1, there is also a problem in that, when repair work is to be performed, it is required to remove the bucket from the construction machinery, and excavation is required to be interrupted for a long period of time. That is, in the construction machinery, it is desired to provide an adhesion suppressing member having both mounting processability and repairability while effectively suppressing work pieces from adhering to a work tool.

The technology of the present disclosure has been made in view of the above-mentioned circumstances, and has an object to improve mounting processability and repairability while effectively suppressing work pieces from adhering to a work tool.

### Solution to Problem

According to the present disclosure, there is provided an adhesion suppressing member (10), which is configured to suppress a work piece from adhering to a work tool (20, 20′, 30, 40, 50, 60, 70, 80) of a construction machinery (100, 200, 300, 400, 500, 600, 700). The adhesion suppressing member (10) is formed in a plate shape and includes, on a front surface thereof, a resin material (12) having a water repellent property, and the adhesion suppressing member (10) is installed at a predetermined portion of the work tool (20, 20′, 30, 40, 50, 60, 70, 80) such that the front surface forms a part of a surface of the work tool (20, 20′, 30, 40, 50, 60, 70, 80) held in contact with the work piece.

The adhesion suppressing member (10) according to another aspect of the present disclosure further includes a metal material (11) having a plate shape, which is bonded to a surface of the resin material (12) on a side opposite to the front surface, and is fixed to the predetermined portion.

A work tool (20, 20′) of the present disclosure is a work tool (20, 20′) including the adhesion suppressing member (10). The construction machinery is a backhoe (100). The work tool (20, 20′) is a bucket (20, 20′), which is turnably mounted to a distal end of an arm (142) of the backhoe (100), and which includes a bottom plate portion (21) and a side plate portion (22, 23) forming an accommodating portion (28) that accommodates the excavated work piece. The adhesion suppressing member (10) is installed on any one or both of the bottom plate portion (21) and the side plate portion (22, 23).

In the work tool (20′) according to another aspect of the present disclosure, the bucket (20′) is a skeleton bucket (20′) in which a plurality of grids (27) are provided to the bottom plate portion (21). The adhesion suppressing member (10) is installed at any one or both of a portion of the bottom plate portion (21) on which the grids (27) are not provided and the side plate portion (22, 23).

In the work tool (20) according to another aspect of the present disclosure, the adhesion suppressing member (10) is formed in an oblong plate shape. The adhesion suppressing member (10) comprises a plurality of adhesion suppressing members (10), which are installed in parallel on the bottom plate portion (21) such that a longitudinal direction of each of the plurality of adhesion suppressing members (10) is substantially parallel to a rotation axis (R) direction of the bucket (20).

In the work tool (20) according to another aspect of the present disclosure, the bottom plate portion (21) includes a flat surface portion (21A) extending from an opening side of the accommodating portion, and a curved surface portion (21B) curved from an end portion of the flat surface portion (21A) on a side opposite to the opening side so as to be convex toward an outer side of the accommodating portion (28). The adhesion suppressing member (10) comprises a plurality of the adhesion suppressing members (10), which are installed on the flat surface portion (21A) and at least a portion of the curved surface portion (21B) on the flat surface portion (21A) side.

In the work tool (20) according to another aspect of the present disclosure, the bucket (20) includes an edge plate portion (24) bonded to an end portion of the bottom plate portion (21) to form a part of an opening edge of the accommodating portion (28). The adhesion suppressing member (10) is installed on at least one or all of the bottom plate portion (21), the side plate portion (22, 23), and the edge plate portion (24).

In the work tool (20) according to another aspect of the present disclosure, the bucket (20) further includes a claw portion (5A to 5E) mounted to a distal end of the edge plate portion (24) through intermediation of an adaptor (4A to 4E). The adhesion suppressing member (10) is installed on at least one or all of the bottom plate portion (21), the side plate portion (22, 23), the edge plate portion (24), and the claw portion (5A to 5E).

The work tool (20) according to another aspect of the present disclosure further includes a vibration generating machine (8A) that is provided to the bucket (20) and is configured to transmit vibration to the bucket (20).

A work tool (30) according to another aspect of the present disclosure is a work tool (30) including the adhesion suppressing member (10). The construction machinery is a wheel loader (200). The work tool is a bucket (30), which is turnably mounted to a distal end of a boom (231) of the wheel loader (200), and which includes a bottom plate portion (31) and a side plate portion (32, 33) forming an accommodating portion (38) that accommodates the work piece. The adhesion suppressing member (10) is installed on any one or both of the bottom plate portion (31) and the side plate portion (32, 33).

A work tool (40) according to another aspect of the present disclosure is a work tool (40) including the adhesion suppressing member (10). The construction machinery is a bulldozer (300). The work tool is a blade (40), which is mounted to a distal end of a support frame (331, 332) of the bulldozer (300), and which is configured to push out the work piece. The adhesion suppressing member (10) is installed on a front face of the blade (40).

A work tool (50) according to another aspect of the present disclosure is a work tool (50) including the adhesion suppressing member (10). The construction machinery is an earth drill excavator (400) to be used in an earth drill method of pile work. The work tool is a drilling bucket (50), which is mounted to a distal end of a kelly bar (450) included in the earth drill excavator (400), and which is configured to take in excavated soil and sand as the work piece and discharge the excavated soil and sand. The drilling bucket (50) includes a bucket main body (51) having a cylindrical shape, and a bottom lid (52) configured to close a lower end opening of the bucket main body. The adhesion suppressing member (10) is installed on any one or both of an inner peripheral surface of the bucket main body (51) and an inner surface of the bottom lid (52).

A work tool (60) according to another aspect of the present disclosure is a work tool (60) including the adhesion suppressing member (10). The construction machinery is an all-casing excavator (500) to be used in an all-casing method of pile work. The work tool is a hammer grab (60), which is suspended from a lifting machine (530) included in the all-casing excavator (500), and which is configured to grab excavated soil and sand as the work piece and discharge the excavated soil and sand. The hammer grab (60) includes a hammer grab main body (61), and a pair of shells (63, 64) openably and closably mounted to a lower end portion of the hammer grab main body (61). The adhesion suppressing member (10) is installed on an inner peripheral surface of each of the pair of shells (63, 64).

A work tool (70) according to another aspect of the present disclosure is a work tool (70) including the adhesion suppressing member. The construction machinery is a horizontal multi-shaft digging machine (600) to be used in an underground continuous wall construction method. The work tool is a pair of rotary cutters (70, 70), which are arranged side by side at a lower end of a digging unit main body (620, 621) included in the horizontal multi-shaft digging machine (600), and which are configured to be rotationally driven to excavate a ground. The rotary cutters (70, 70) each include a rotary drum (71) having a cylindrical shape, and a plurality of blades (72) provided on an outer peripheral surface of the rotary drum (71) so as to protrude in a radial direction, each of the plurality of blades (72) having a cutter bit (74) fixed to a distal end of each of the plurality of blades (72). The adhesion suppressing member (10) is installed on a front surface of each of the plurality of blades (72).

A work tool (80) according to another aspect of the present disclosure is a work tool (80) including the adhesion suppressing member (10). The construction machinery is a ground improvement machine (700) to be used in a power blender method. The work tool is a trencher-type stirring mixing machine (80) included in the ground improvement machine (700). The trencher-type stirring mixing machine (80) includes a frame (81) having a columnar shape, sprockets (82, 83) provided to an upper end and a lower end of the frame (81), respectively, an endless chain (84) wound around each of the sprockets (82, 83), and a plurality of stirring blades (88) provided on an outer periphery of the endless chain (84). The adhesion suppressing member (10) is installed on any one or both of a front surface of the frame (81) and a front surface of each of the stirring blades (88).

A claw member (5F) according to the present disclosure is a claw member (5F) configured to be mounted to the work tool (20). The claw member (5F) includes a claw main body portion (5G) having a flat surface portion (5H) formed to have a length substantially equal to an opening width of the bucket (20). The claw main body portion (5G) is mounted to a distal end of the edge plate portion (24) through intermediation of an adaptor (4A to 4E), and the adhesion suppressing member (10) is installed on the flat surface portion (5H).

An adhesion suppressing method according to the present disclosure is an adhesion suppressing method using the adhesion suppressing member (10), and includes installing the adhesion suppressing member (10) on the predetermined portion of the work tool (20, 20′, 30, 40, 50, 60, 70, 80) such that the front surface of the adhesion suppressing member forms a part of the surface of the work tool (20, 20′, 30, 40, 50, 60, 70, 80) held in contact with the work piece.

In the above description, in order to facilitate the understanding of the present disclosure, reference symbols used in embodiments are enclosed in parentheses and assigned to the components corresponding to the embodiments. However, each of the components is not limited to the embodiments defined by the reference symbols.

### Advantageous Effects of Invention

According to the technology of the present disclosure, it is possible to improve mounting processability and repairability while effectively suppressing the work pieces from adhering to the work tool.

### BRIEF DESCRIPTION OF DRAWINGS

FIG. 1 is a schematic side view for illustrating a construction machinery of a first embodiment.

FIG. 2 is a schematic perspective view for illustrating a bucket according to the first embodiment.

FIG. 3 is a perspective view for schematically illustrating soil adhering to an inner surface of the bucket.

FIG. 4(A) is a schematic perspective view for illustrating an adhesion suppressing member according to this embodiment.

FIG. 4(B) is a sectional view taken along the line A-A of FIG. 4(A).

FIG. 5 is an explanatory schematic perspective view for illustrating an example of installing the adhesion suppressing members on the inner surface of the bucket.

FIG. 6 is an explanatory schematic view for illustrating bonding patterns of the adhesion suppressing members of Verification Experiment 1.

FIG. 7 is an explanatory schematic graph for showing results of Verification Experiment 1.

FIG. 8 is an explanatory schematic view for illustrating bonding patterns of the adhesion suppressing members of Verification Experiment 2.

FIG. 9 is an explanatory schematic graph for showing results of Verification Experiment 2.

FIG. 10 is an explanatory schematic view for illustrating bonding patterns of the adhesion suppressing members of Verification Experiment 3.

FIG. 11 is an explanatory schematic graph for showing results of Verification Experiment 3.

FIG. 12 is an explanatory schematic graph for showing results of a noise test.

FIG. 13 is a schematic perspective view for illustrating a bucket of Modification Example 1 according to the first embodiment.

FIG. 14 is a schematic perspective view for illustrating a bucket of Modification Example 2 according to the first embodiment.

FIG. 15 is a schematic perspective view for illustrating a bucket of Modification Example 3 according to the first embodiment.

FIG. 16 is a schematic perspective view for illustrating a bucket of Modification Example 4 according to the first embodiment.

FIG. 17 is a schematic side view for illustrating a construction machinery of a second embodiment.

FIG. 18 is a schematic perspective view for illustrating a bucket according to the second embodiment.

FIG. 19 is a schematic side view for illustrating a construction machinery of a third embodiment.

FIG. 20 is a schematic perspective view for illustrating a blade according to the third embodiment.

FIG. 21 is a schematic side view for illustrating a construction machinery of a fourth embodiment.

FIG. 22 is a schematic side view for illustrating a drilling bucket according to the fourth embodiment.

FIG. 23 is a schematic longitudinal sectional view for illustrating the drilling bucket according to the fourth embodiment.

FIG. 24 is a schematic side view for illustrating a construction machinery of a fifth embodiment.

FIG. 25 is a schematic perspective view for illustrating a state in which a hammer grab according to the fifth embodiment is closed.

FIG. 26 is a schematic perspective view for illustrating a state in which the hammer grab according to the fifth embodiment is opened.

FIG. 27 is a schematic side view for illustrating a construction machinery of a sixth embodiment.

FIG. 28 is a schematic view of a rotary cutter according to the sixth embodiment as viewed from a rotation axis direction.

FIG. 29 is a schematic view of the rotary cutter according to the sixth embodiment as viewed from a radial direction.

FIG. 30 is a schematic side view for illustrating a construction machinery of a seventh embodiment.

FIG. 31 is a schematic perspective view for illustrating a trencher-type stirring mixing machine according to the seventh embodiment.

FIG. 32 is a schematic plan view of a modification example according to the seventh embodiment.

FIG. 33 is a schematic side view of the modification example according to the seventh embodiment.

### DESCRIPTION OF EMBODIMENTS

Now, with reference to the drawings, an adhesion suppressing member, a work tool, a claw member, and an adhesion suppressing method according to this embodiment are described.

### Construction Machinery of First Embodiment

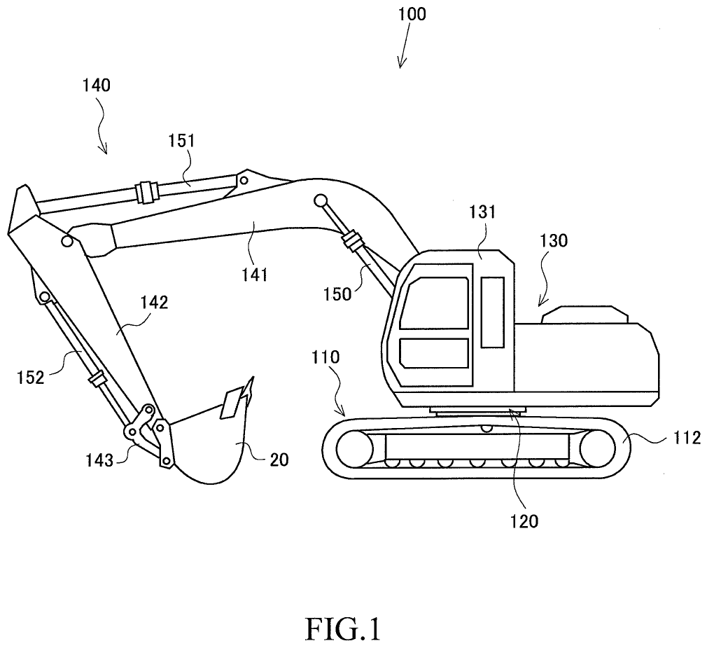

FIG. 1 is a schematic side view for illustrating a construction machinery of a first embodiment. The construction machinery is, for example, a backhoe 100 (hydraulic excavator) including a bucket 20 as a work tool. The construction machinery is not limited to the backhoe 100, and may be, for example, a wheel loader as long as the wheel loader is a construction machinery including a bucket. Further, the construction machinery may be, for example, a dozer or a grader including a blade as a work tool. In the following, the construction machinery is described using the backhoe 100 as an example.

The backhoe 100 includes a lower traveling body 110, a turning machine 120, an upper turning body 130, and a working machine 140. The lower traveling body 110 includes a crawler 112 and a drive machine (not shown). The backhoe 100 travels when the crawler 112 is driven by power transmitted from the drive machine.

The upper turning body 130 is supported on the lower traveling body 110 through intermediation of the turning machine 120. The upper turning body 130 is driven to turn when the turning machine 120 operates with power from a hydraulic motor (not shown). The upper turning body 130 includes a cabin 131. An operator who maneuvers the backhoe 100 gets in the cabin 131. The backhoe 100 may operate through remote operation, or may operate through automatic drive control. In this case, the backhoe 100 is not required to include the cabin 131.

The working machine 140 includes a boom 141, an arm 142, a bucket link 143, a bucket 20 as a work tool, and a plurality of cylinders 150, 151, and 152. A proximal end side of the boom 141 is turnably supported on the upper turning body 130. A proximal end side of the arm 142 is turnably supported on a distal end side of the boom 141. The bucket 20 is turnably supported on a distal end side of the arm 142. The bucket link 143 couples the arm 142 and the bucket 20 to each other.

The boom cylinder 150 is connected to the upper turning body 130 and the boom 141. When the boom cylinder 150 expands and contracts, the boom 141 turns with respect to the upper turning body 130. The arm cylinder 151 is connected to the boom 141 and the arm 142. When the arm cylinder 151 expands and contracts, the arm 142 turns with respect to the boom 141.

The bucket cylinder 152 is connected to the arm 142 and the bucket link 143. When the bucket cylinder 152 expands and contracts, the bucket 20 turns with respect to the arm 142. A preliminary attachment such as a tilt rotator that rotates the bucket 20 about an axis of the arm 142 may be interposed between the bucket 20 and the arm 142.

### Bucket (Work Tool)

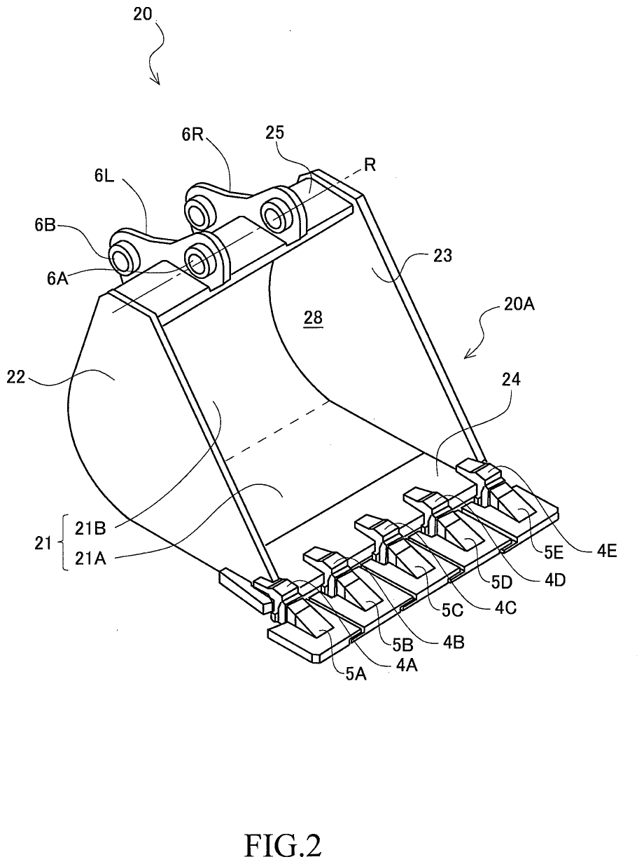

FIG. 2 is a schematic perspective view for illustrating the bucket 20 according to the first embodiment. In the following, the rotation axis R direction of the bucket 20 may be referred to as “left-and-right direction” or “width direction.” In FIG. 2, the bucket 20 is illustrated as a so-called standard bucket, but may be a narrow bucket or a wide bucket. Further, the bucket 20 may be of other types of bucket, such as a normal bucket, a multipurpose bucket, a material handling bucket, or a grab bucket.

The bucket 20 is made of, for example, a steel material, and includes a bucket main body portion 20A, a plurality of adaptors 4A to 4E, a plurality of claw portions 5A to 5E, and a pair of brackets 6L and 6R.

The bucket main body portion 20A includes a bottom plate portion 21, a left side plate portion 22, a right side plate portion 23, an edge plate portion 24, and a bracket fixing plate portion 25. The bottom plate portion 21 and the side plate portions 22 and 23 form an accommodating portion 28 for accommodating work pieces, such as excavated soil and sand or mud.

The bottom plate portion 21 includes a flat surface portion 21A extending from an opening side of the accommodating portion 28 in a substantially planar state, and a curved surface portion 21B curved so as to be convex from an end portion of the flat surface portion 21A toward an outer side of the accommodating portion 28. The flat surface portion 21A and the curved surface portion 21B may each be one plate material, or may be formed by joining separate plate materials to each other by welding or the like. The edge plate portion 24 is fixed to an end portion of the flat surface portion 21A on a side opposite to the curved surface portion 21B by welding. The bracket fixing plate portion 25 is fixed to an end portion of the curved surface portion 21B on a side opposite to the flat surface portion 21A by welding. The left side plate portion 22 is fixed to the bottom plate portion 21, the edge plate portion 24, and the left end portion of the bracket fixing plate portion 25 by welding. The right side plate portion 23 is fixed to the bottom plate portion 21, the edge plate portion 24, and the right end portion of the bracket fixing plate portion 25 by welding.

The plurality of adaptors 4A to 4E are fixed to the edge plate portion 24 at a predetermined interval in the left-and-right direction. The plurality of claw portions 5A to 5E are removably mounted to the plurality of adaptors 4A to 4E, respectively. In FIG. 2, the claw portions 5A to 5E are illustrated as flat claws, but may be drilling claws each thinned toward a distal end.

The pair of brackets 6L and 6R are provided on an outer surface of the bracket fixing plate portion 25 on a side opposite to the accommodating portion 28, and face each other at a predetermined distance in the left-and-right direction. The brackets 6L and 6R have a pair of through holes 6A and 6B formed therein. A pin (not shown) for coupling the bucket main body portion 20A to the arm 142 (see FIG. 1) is inserted through the through hole 6A on the opening side. A pin (not shown) for coupling the bucket main body portion 20A to the bucket link 143 (see FIG. 1) is inserted through the through hole 6B on the back side. The bucket 20 is configured to turn about an axis of the through hole 6A when the bucket cylinder 152 (see FIG. 1) is expanded and contracted. That is, the axis of the through hole 6A matches the rotation axis R of the bucket 20.

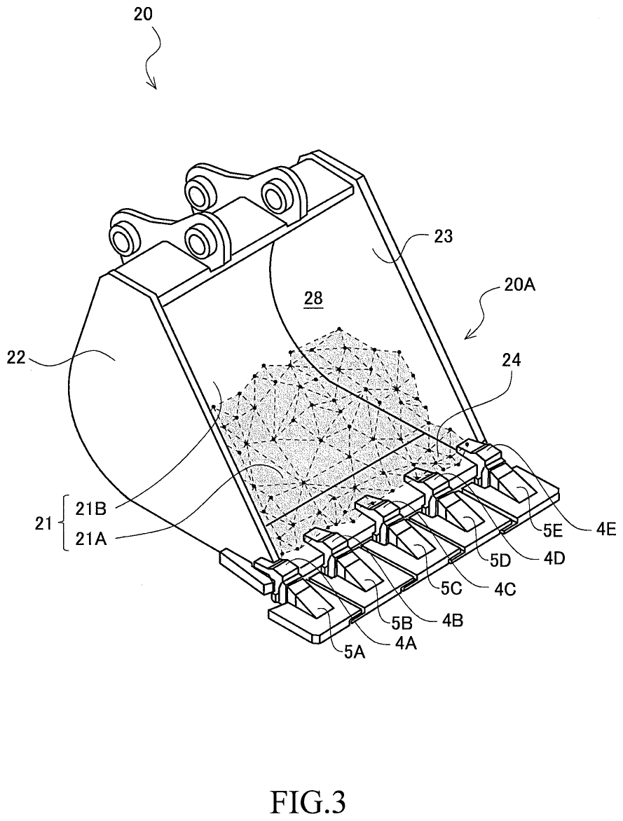

Here, a case in which the bucket 20 excavates a soil material such as soil and sand including clay containing water is considered. The soil material containing water has a property of being liable to adhere to an inner surface of the bucket 20 formed of a steel material. The soil material containing water as described above has a tendency of being liable to adhere to, as indicated by gray in FIG. 3, (1) the edge plate portion 24, (2) the flat surface portion 21A of the bottom plate portion 21 and a portion of the curved surface portion 21B on the flat surface portion 21A side, and (3) portions of the side plate portions 22 and 23 on the edge plate portion 24 side and the flat surface portion 21A side, of the bucket main body portion 20A. Further, when the claw portions 5A to 5E are of flat claw type, soil is also liable to adhere between the claw portions 5A to 5E.

When the soil adheres to and deposits on the inner surface of the bucket 20, the substantial volume of the accommodating portion 28 decreases, which results in causing a decrease in work efficiency. When adhesion residual soil deposits inside the bucket 20, the adhesion residual soil can be shaken out by swinging the bucket 20 or giving an impact to the bucket 20, but large noise or vibration is generated. Further, when the backhoe 100 is operated by automatic driving, it is difficult that the system side intentionally swings the bucket 20. Thus, when automatic driving is continued for a certain period time or more, the automatic driving is to be temporarily interrupted, and the bucket 20 is to be cleaned. However, there is a problem in that a worker is required to approach the bucket 20, and hence safety cannot be secured.

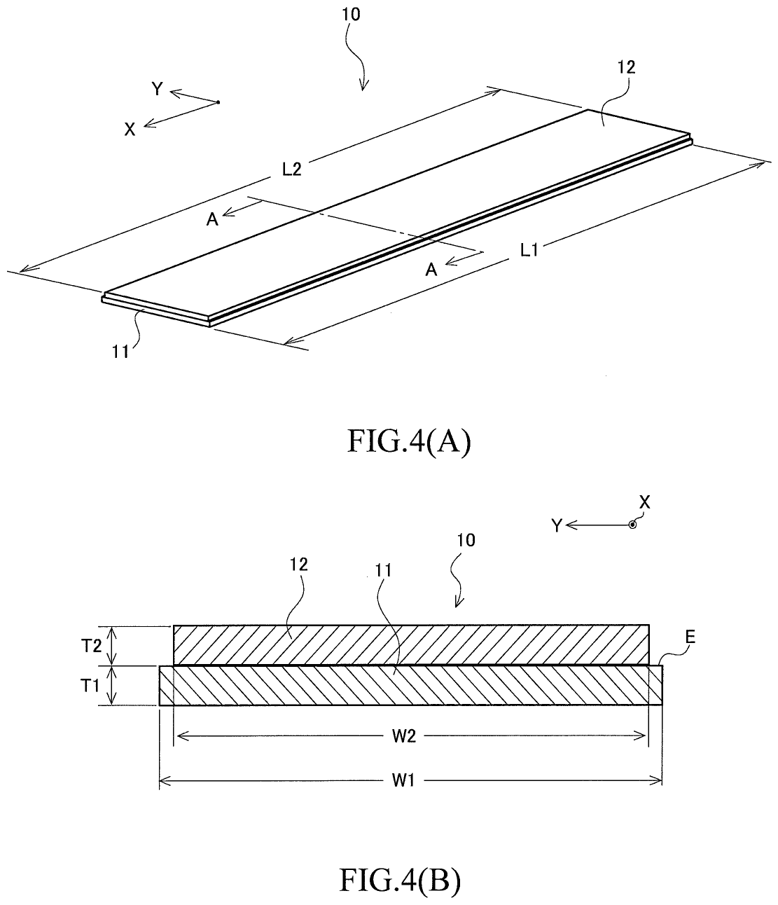

In view of this, in the first embodiment, the adhesion suppressing members 10 as illustrated in FIG. 4 are installed on the inner surface of the bucket 20 to suppress the soil from adhering to the inner surface of the bucket 20. Now, the adhesion suppressing member 10 is described in detail.

### Adhesion Suppressing Member

FIG. 4(A) is a schematic perspective view for illustrating the adhesion suppressing member 10 according to this embodiment. FIG. 4(B) is a sectional view taken along the line A-A of FIG. 4(A).

As illustrated in FIG. 4(A), the adhesion suppressing member 10 has a rectangular strip shape (oblong plate shape) as a whole, and has a two-layer structure in which a metal material 11 as a lower layer and a resin material 12 as an upper layer are joined to each other. In the following, a direction in which the long side of the adhesion suppressing member 10 extends is referred to as “longitudinal direction X,” and a direction in which the short side thereof extends is referred to as “short-side direction Y.”

The metal material 11 is, for example, a plate-shaped steel material, and, in this embodiment, is formed of a stainless steel excellent in corrosion resistance. The metal material 11 may be formed using carbon steel, tool steel, or the like. A length W1 (see FIG. 4(B)) of the metal material 11 in the short-side direction Y is not particularly limited, and, in this embodiment, is from about 90 mm to about 110 mm, preferably about 105 mm. It is only required that a length L1 (see FIG. 4(A)) of the metal material 11 in the longitudinal direction X be set to an appropriate length in accordance with the width of the bucket 20, for example, from 500 mm to 2,000 mm. It is preferred that a thickness T1 (see FIG. 4(B)) of the metal material 11 be a thickness that allows a worker to grasp both ends of the adhesion suppressing member 10 in the short-side direction Y and curve the adhesion suppressing member 10 by human power so as to be plastically deformed. In this embodiment, the thickness T1 of the metal material 11 is from about 0.1 mm to about 1 mm, preferably, about 0.5 mm.

The resin material 12 is, for example, a plate-shaped fluororesin material, and, in this embodiment, is formed of polytetrafluoroethylene (hereinafter, “PTFE”). PTFE is extremely small in surface free energy (surface tension), and excellent in water repellent property or oil repellent property, thereby being capable of effectively suppressing adhesion of soil. The resin material 12 is not limited to PTFE, and, for example, perfluoro alkoxy alkane (PFA), perfluoro ethylene propylene copolymer (FEP), ethylene tetrafluoroethylene copolymer (ETFE), polyvinylidene fluoride/vinylidene fluoride/polyvinylidene fluoride (PVDF), or the like can be used.

A length W2 (see FIG. 4(B)) of the resin material 12 in the short-side direction Y is not particularly limited, and, in this embodiment, is from about 90 mm to about 105 mm, preferably about 100 mm. It is only required that a length L2 (see FIG. 4(A)) of the resin material 12 in the longitudinal direction X be set to be an appropriate length in accordance with the width of the bucket 20 similarly to the length L1 of the metal material 11. A thickness T2 (see FIG. 4(B)) of the resin material 12 is not particularly limited, and, in this embodiment, is from about 0.1 mm to about 1 mm, preferably about 0.5 mm.

Here, fluororesin used for the resin material 12 is a hard-to-adhere material, and it is difficult to simply join the resin material 12 and the metal material 11 to each other. The resin material 12 and the metal material 11 may be joined using, for example, a joining method as disclosed in JP 2022-049070 A. Now, the overview of the joining method is simply described.
Step (1): Laser light is radiated onto a surface (joining surface) of the metal material 11 on a side to be joined to the resin material 12 under an oxidizing atmosphere to form a metal oxide particle cluster in which metal oxide particles are continuous on the joining surface of the metal material 11.
Step (2): The metal material 11 having the metal oxide particle cluster formed thereon is brought into abutment against the resin material 12 to form a joined interface.
Step (3): Laser light is radiated to raise the temperature of the joined interface, and the metal material 11 and the resin material 12 are brought into close contact with each other using a roller to apply a pressure to the joined interface.

The adhesion suppressing member 10 manufactured by Steps (1) to (3) described above is higher in the joining strength between the resin material 12 and the metal material 11 and can withstand an impact or the like at the time of excavation without causing peeling between the resin material 12 and the metal material 11.

The method of joining the metal material 11 and the resin material 12 to each other is not limited to Steps (1) to (3) described above, and other well-known methods can also be used. In the following description, a surface of the metal material 11 on a side opposite to the joined interface is referred to as “back surface” of the adhesion suppressing member 10, and a surface of the resin material 12 on a side opposite to the joined interface is referred to as “front surface” of the adhesion suppressing member 10.

### Installation of Adhesion Suppressing Members of First Embodiment

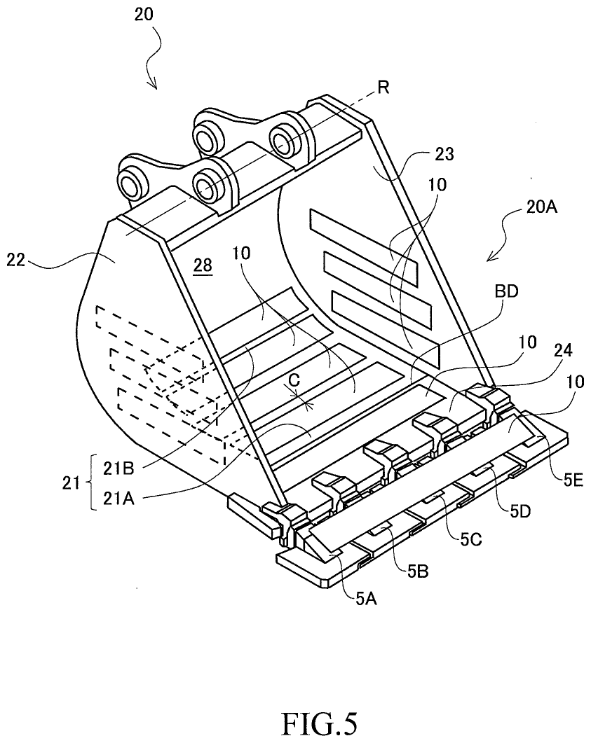

FIG. 5 is an explanatory schematic perspective view for illustrating an example of installing the adhesion suppressing members 10 of the first embodiment on the inner surface of the bucket 20.

The adhesion suppressing member 10 may be bonded to the inner surface of the bucket 20 with a double-sided tape bonded to the back surface (preferably, the entire back surface) or may be bonded to the inner surface of the bucket 20 with an adhesive applied to the back surface. When the double-sided tape is used, an adhesion mark is less liable to remain at the time of replacing the adhesion suppressing member 10 with a new one, thereby being capable of easily performing replacement work. The type of the double-sided tape is not particularly limited, but it is preferred to use a double-sided tape for outdoor use, which has a strong adhesive force.

The installation of the adhesion suppressing member 10 is not limited to a method of using a double-sided tape or an adhesive, and an edge portion E (see FIG. 4(B)) of the metal material 11 which protrudes more than the resin material 12 may be fixed to the inner surface of the bucket 20 by spot welding or a predetermined portion of the adhesion suppressing member 10 may be fixed using a rivet or a bolt. Now, description is made with the assumption that the adhesion suppressing member 10 is bonded using a double-sided tape.

As illustrated in FIG. 5, the plurality of adhesion suppressing members 10 are installed on a portion of the inner surface of the bucket 20 to which work pieces, such as soil and sand including clay containing water or mud, are liable to adhere (see gray in FIG. 3). Specifically, the adhesion suppressing members 10 are bonded to (1) the edge plate portion 24, (2) the flat surface portion 21A of the bottom plate portion 21 and the portion of the curved surface portion 21B on the flat surface portion 21A side, or (3) portions of the side plate portions 22 and 23 on the flat surface portion 21A side.

The adhesion suppressing members 10 for the edge plate portion 24 and the bottom plate portion 21 are bonded such that the longitudinal direction is substantially parallel to the rotation axis R direction of the bucket 20. A bead BD is formed by welding at the boundary portion between the edge plate portion 24 and the bottom plate portion 21. When the adhesion suppressing member 10 interferes with the bead BD, the adhesion suppressing member 10 is liable to be peeled off due to an impact or the like at the time of excavation work. Thus, the adhesion suppressing members 10 are bonded so as to avoid the bead BD in the vicinity of the boundary between the edge plate portion 24 and the bottom plate portion 21.

The adhesion suppressing member 10 for the curved surface portion 21B is plastically deformed by curving the adhesion suppressing member 10 in advance so as to follow the curved surface portion 21B, and then, is bonded. When the adhesion suppressing member 10 is curved and bonded, the adhesion strength of the adhesion suppressing member 10 with respect to the curved surface portion 21B can be improved. In the illustrated example, one adhesion suppressing member 10 is bonded to the edge plate portion 24, and four adhesion suppressing members 10 in total are bonded to the bottom plate portion 21. However, the number of adhesion suppressing members 10 is not limited thereto, and it is only required that an appropriate number of adhesion suppressing members 10 in accordance with specific dimensions of each of the edge plate portion 24 and the bottom plate portion 21 be bonded.

The adhesion suppressing members 10 for the side plate portions 22 and 23 are bonded such that the longitudinal direction is substantially parallel to the plane direction of the flat surface portion 21A. In the side plate portions 22 and 23, it is only required that the adhesion suppressing members 10 be at least bonded to portions on the flat surface portion 21A side. In the illustrated example, three adhesion suppressing members 10 are bonded to each of the left side plate portion 22 and the right side plate portion 23. However, the number of adhesion suppressing members 10 is not limited thereto, and it is only required that an appropriate number of adhesion suppressing members 10 in accordance with specific dimensions of each of the side plate portions 22 and 23 be bonded.

A plurality of adhesion suppressing members 10 may be bonded so as to be bedded. However, when end portions of adjacent adhesion suppressing members 10 are held in contact with each other, due to an impact, vibration, or the like at the time of excavation work, the end portions of the adhesion suppressing members 10 interfere with each other, and hence there is a possibility in that peeling is liable to occur. Thus, it is preferred that a plurality of adhesion suppressing members 10 be bonded at a predetermined clearance C. The specific numerical value of the clearance C is not particularly limited, but an effect of suppressing adhesion of soil is obtained as the clearance Cis narrower. In this embodiment, the clearance C is set to be from 20 mm to 90 mm, preferably set to be 30 mm.

In the example illustrated in FIG. 5, the claw portions 5A to 5E mounted to the bucket 2 are of so-called flat claw type. When the claw portions 5A to 5E are of flat claw type, soil is liable to adhere also between the claw portions 5A to 5E. Thus, it is preferred that the adhesion suppressing members 10 be bonded also to the claw portions 5A to 5E.

As described above, when the adhesion suppressing member 10 is bonded to the inner surface of the bucket 20, the resin material 12 forming the front surface of the adhesion suppressing member 10 is small in surface free energy. Thus, the excavated soil accommodated in the bucket 20 is difficult to adhere to the front surface of the adhesion suppressing member 10. That is, the excavated soil accommodated in the bucket 20 can be effectively discharged without being accumulated in the bucket 20. With this, the substantial capacity of the bucket 20 can be effectively suppressed from decreasing, thereby being capable of reliably preventing the decrease in work efficiency. Further, swing for shaking out the adhesion residual soil from the inside of the bucket 20 or application of an impact are almost unnecessary or the number thereof can be extremely reduced, thereby also being capable of effectively preventing occurrence of large noise or vibration. Further, accumulation of fatigue caused by swing or an impact of the bucket 20 can be effectively reduced, thereby also being capable of prolonging the life to a periodic replacement. Further, a worker is not required to approach the bucket 20 for cleaning, thereby also being capable of improving safety.

Further, the metal material 11 and the resin material 12 are small in thickness, and hence can be easily deformed so that the adhesion suppressing members 10 can be closely bonded to the curved surface portion 21B of the bottom plate portion 21. Further, the adhesion suppressing members 10 have a strip shape, and hence can be bonded while avoiding the bead BD at the boundary between the edge plate portion 24 and the bottom plate portion 21, and the like. That is, the mounting processability can also be effectively improved while reliably improving an adhesive property of the adhesion suppressing members 10 with respect to the bucket 20.

Further, the plurality of adhesion suppressing members 10 are bonded to the inner surface of the bucket 20 independently of each other. Thus, when some of the adhesion suppressing members 10 are broken due to an impact or the like at the time of excavation or degraded due to the long-term use, it is only required to replace only the broken or degraded adhesion suppressing member 10. That is, the replacement work can be performed while maintaining a state in which the bucket 20 is mounted to the backhoe 100, thereby being capable of reliably improving repairability. Further, the replacement work can be performed in a short period of time, thereby being capable of minimizing the influence on the excavation work or the work period.

### Verification Experiment 1

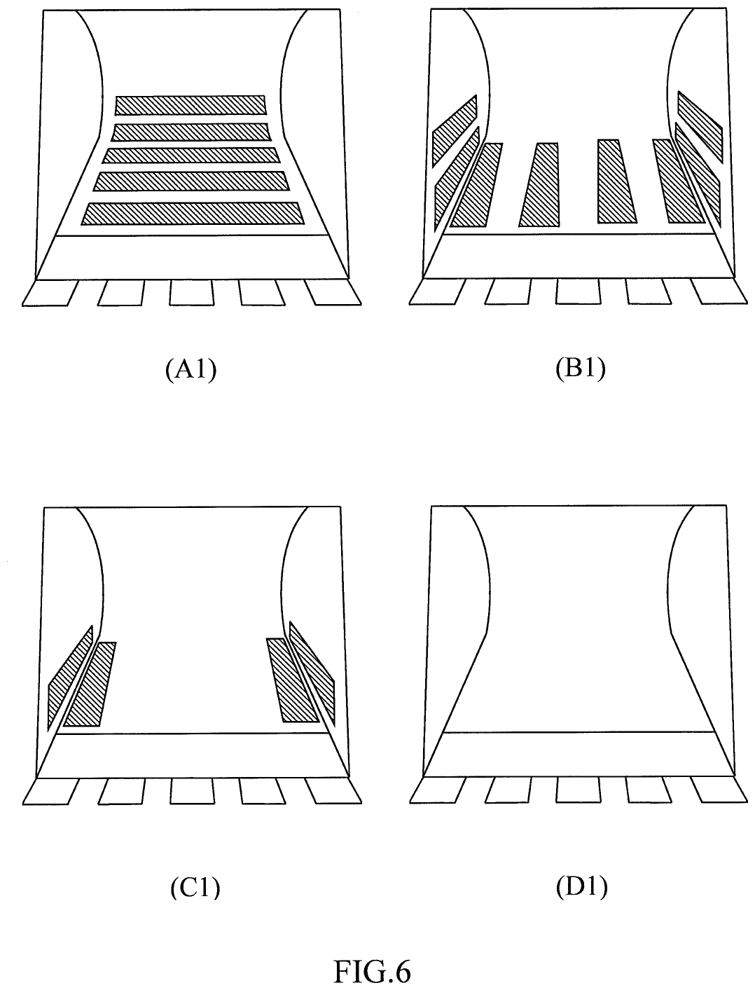

The adhesion suppressing members 10 were attached to the bucket of the backhoe, and a verification experiment of confirming an effect of soil adhesion suppression was performed. FIG. 6 is an explanatory schematic view for illustrating bonding patterns of the adhesion suppressing members 10 of Verification Experiment 1. In FIG. 6, the adhesion suppressing members 10 are hatched. The adhesion suppressing members 10 were bonded to the bucket inner surface using a double-sided tape.

In a pattern (A1), one adhesion suppressing member 10 was bonded to the edge plate portion such that the longitudinal direction was substantially parallel to the rotation axis direction of the bucket. Further, five adhesion suppressing members 10 in total were bonded to the flat surface portion and the curved surface portion of the bottom plate portion in parallel such that the longitudinal direction was substantially parallel to the rotation axis direction of the bucket. The clearance between the adhesion suppressing members 10 was set to be about 30 mm. The value obtained by dividing the sum of the surface areas of the front surfaces of the adhesion suppressing members 10 by the surface area of the bucket inner surface (hereinafter, “PTFE area ratio”) was about 36%.

In a pattern (B1), four adhesion suppressing members 10 in total were bonded in parallel to the bottom plate portion such that the longitudinal direction was substantially orthogonal to the rotation axis direction of the bucket. Further, two adhesion suppressing members 10 in total were bonded in parallel to each of the left side plate portion and the right side plate portion such that the longitudinal direction was substantially parallel to the plane direction of the flat surface portion of the bottom plate portion. The clearance between the adhesion suppressing members 10 was set to be about 130 mm. The PTFE area ratio was about 25%.

In a pattern (C1), one adhesion suppressing member 10 was bonded to each of the vicinity of the left side plate portion and the vicinity of the right side plate portion of the bottom plate portion such that the longitudinal direction was substantially orthogonal to the rotation axis direction of the bucket. Further, one adhesion suppressing member 10 was bonded to the vicinity of the bottom plate portion of the left side plate portion and the vicinity of the bottom plate portion of the right side plate portion such that the longitudinal direction was substantially parallel to the plane direction of the flat surface portion of the bottom plate portion. The PTFE area ratio was about 12%.

A pattern (D1) is a comparative example in which the adhesion suppressing members 10 are not bonded to the bucket. The PTFE area ratio was 0%.

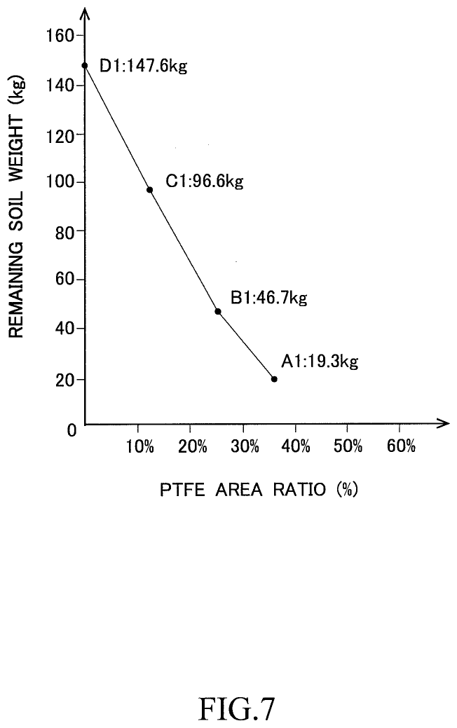

In Verification Experiment 1, a series of operations of scooping heaped swampy soil into the bucket and discharging the swampy soil to another location was performed ten times, then the remaining soil in the bucket was scraped off, and the weight of the remaining soil was measured by a gravimeter. FIG. 7 shows a measurement result of the weight of the remaining soil. The weight of the remaining soil in the pattern (A1) was 19.3 kg. The weight of the remaining soil in the pattern (B1) was 46.7 kg. The weight of the remaining soil in the pattern (C1) was 96.6 kg. The weight of the remaining soil in the pattern (D1) was 147.6 kg.

It was confirmed from the measurement results described above that, even in the pattern (C1) in which the adhesion suppressing members 10 were attached only to the vicinity of the boundary between the bottom plate portion and the side plate portion, the weight of the remaining soil could be reduced more than that in the pattern (D1) of the comparative example, thereby being capable of obtaining a certain soil adhesion suppression effect. Further, it was confirmed that, even when the longitudinal direction of the adhesion suppressing member 10 was orthogonal to the rotation axis direction of the bucket, in the pattern (B1) in which the adhesion suppressing members 10 were bonded to both the bottom plate portion and the side plate portion, the weight of the remaining soil could be more significantly reduced than that in the pattern (D1) of the comparative example. Further, it was confirmed that, in the pattern (A1) in which the adhesion suppressing members 10 were bonded such that the longitudinal direction of the adhesion suppressing member 10 was substantially parallel to the rotation axis direction of the bucket and the clearance was about 30 mm, the weight of the remaining soil could be reduced more significantly than that in the pattern (D1) of the comparative example, and further, the weight of the remaining soil could be reduced more than that in the pattern (B1).

That is, it could be confirmed that, when the adhesion suppressing members 10 were bonded such that the longitudinal direction was substantially parallel to the rotation axis direction of the bucket and the clearance was small, the highest soil adhesion suppression effect could be obtained. Further, it could be confirmed that, even when the longitudinal direction was substantially orthogonal to the rotation axis direction of the bucket, when the adhesion suppressing members 10 were bonded to both the bottom plate portion and the side plate portion, a high soil adhesion suppression effect was obtained. Further, it could be confirmed that, even when the number of adhesion suppressing members 10 was small, when the adhesion suppressing member 10 was bonded to the vicinity of the boundary between the bottom plate portion and the side plate portion, a certain soil adhesion suppression effect was obtained.

### Verification Experiment 2

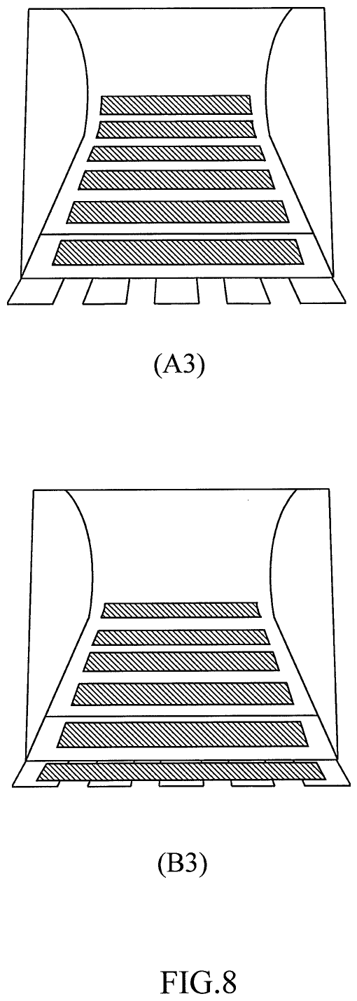

In Verification Experiment 2, it was confirmed whether there was a difference in the soil adhesion suppression effect between a case in which the adhesion suppressing members 10 were bonded to the depth (curved surface portion) side of the bottom plate portion of the bucket and a case in which the adhesion suppressing members 10 were bonded to the claw portions without bonding the adhesion suppressing members 10 to the depth side of the bottom plate portion. FIG. 8 is an explanatory schematic view for illustrating bonding patterns of the adhesion suppressing members 10 in Verification Experiment 2. Similarly to Verification Experiment 1, the adhesion suppressing members 10 were bonded to the bucket inner surface using a double-sided tape.

A pattern (A3) is similar to the pattern (A1) of Verification Experiment 1. That is, one adhesion suppressing member 10 was bonded to the edge plate portion such that the longitudinal direction was substantially parallel to the rotation axis direction of the bucket. Further, five adhesion suppressing members 10 in total were bonded in parallel to the flat surface portion and the curved surface portion of the bottom plate portion such that the longitudinal direction was substantially parallel to the rotation axis direction of the bucket. The clearance between the adhesion suppressing members 10 was set to be about 30 mm.

In a pattern (B3), one adhesion suppressing member 10 was bonded to the edge plate portion such that the longitudinal direction was substantially parallel to the rotation axis direction of the bucket. Further, four adhesion suppressing members 10 in total were bonded in parallel mainly to the flat surface portion of the bottom plate portion such that the longitudinal direction was substantially parallel to the rotation axis direction of the bucket. The clearance between the adhesion suppressing members 10 was set to be about 30 mm. Further, one adhesion suppressing member 10 was bonded to the claw portion such that the longitudinal direction was substantially parallel to the rotation axis direction of the bucket.

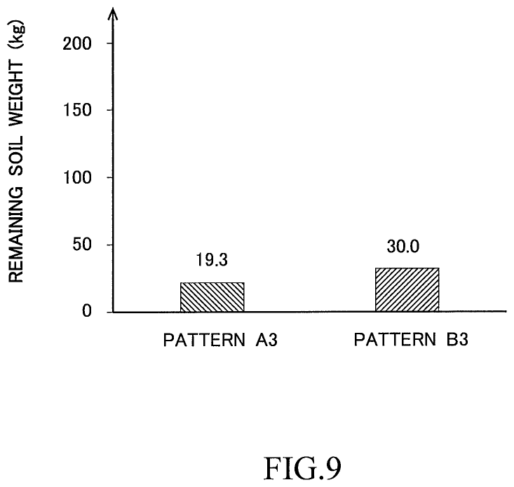

Also in Verification Experiment 2, similarly to Verification Experiment 1, a series of operations of scooping heaped swampy soil into the bucket and discharging the heaped swampy soil to another location was performed ten times in total, then the remaining soil in the bucket was scraped off, and the weight of the remaining soil was measured with a gravimeter. FIG. 9 shows the measurement result of the weight of the remaining soil. The weight of the remaining soil in the pattern (A3) was 19.3 kg. The weight of the remaining soil in the pattern (B3) was 30.0 kg.

It was confirmed from the measurement results described above that a higher soil adhesion suppression effect could be obtained in the case in which the adhesion suppressing members 10 were intensively bonded to the flat surface portion and the curved surface portion of the bottom plate portion (depth side of the bottom plate portion) even when the adhesion suppressing members 10 were not bonded to the claw portions (pattern (A3): bottom plate portion depth side>pattern (B3): claw portion).

### Verification Experiment 3

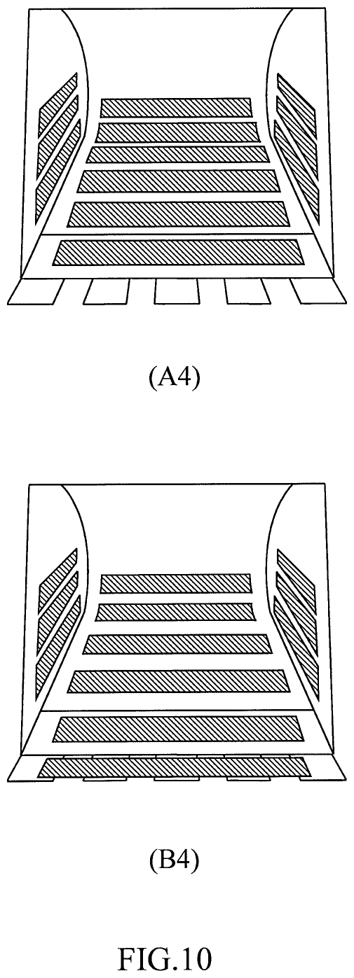

In Verification Experiment 3, it was confirmed whether there was a difference in the soil adhesion suppression effect in accordance with the setting of the clearance between the adhesion suppressing members 10. FIG. 10 is an explanatory schematic view for illustrating bonding patterns of the adhesion suppressing members 10 in Verification Experiment 3. Similarly to Verification Experiment 1, the adhesion suppressing members 10 were bonded to the bucket inner surface using a double-sided tape.

In a pattern (A4), one adhesion suppressing member 10 was bonded to the edge plate portion such that the longitudinal direction was substantially parallel to the rotation axis direction of the bucket. Further, five adhesion suppressing members 10 in total were bonded in parallel to the flat surface portion and the curved surface portion of the bottom plate portion such that the longitudinal direction was substantially parallel to the rotation axis direction of the bucket. Further, three adhesion suppressing members 10 in total were bonded in parallel to each of the left side plate portion and the right side plate portion such that the longitudinal direction was substantially parallel to the plane direction of the flat surface portion of the bottom plate portion. The clearance between the adhesion suppressing members 10 was set to be about 30 mm.

In a pattern (B4), one adhesion suppressing member 10 was bonded to the edge plate portion such that the longitudinal direction was substantially parallel to the rotation axis direction of the bucket. Further, four adhesion suppressing members 10 in total were bonded in parallel to the flat surface portion and the curved surface portion of the bottom plate portion such that the longitudinal direction was substantially parallel to the rotation axis direction of the bucket. Further, three adhesion suppressing members 10 in total were bonded in parallel to each of the left side plate portion and the right side plate portion such that the longitudinal direction was substantially parallel to the plane direction of the flat surface portion of the bottom plate portion. The clearance between the adhesion suppressing members 10 was set to be about 90 mm. Further, one adhesion suppressing member 10 was bonded to the claw portion such that the longitudinal direction was substantially parallel to the rotation axis direction of the bucket.

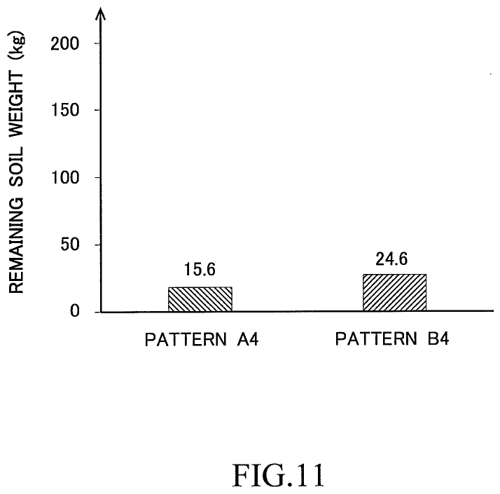

Also in Verification Experiment 3, similarly to Verification Experiment 1, a series of operations of scooping heaped swampy soil into the bucket and discharging the heaped swampy soil to another location was performed ten times in total, then the remaining soil in the bucket was scraped off, and the weight of the remaining soil was measured with a gravimeter. FIG. 11 shows the measurement result of the weight of the remaining soil. The weight of the remaining soil in the pattern (A4) was 15.6 kg. The weight of the remaining soil in the pattern (B4) was 24.6 kg.

It was confirmed from the measurement results described above that a higher soil adhesion suppression effect was obtained in a case in which the clearance was set to be smaller even when the adhesion suppressing members 10 were not bonded to the claw portions (pattern (A4): priority in bottom plate portion>pattern (B4): claw portion).

### Noise Test

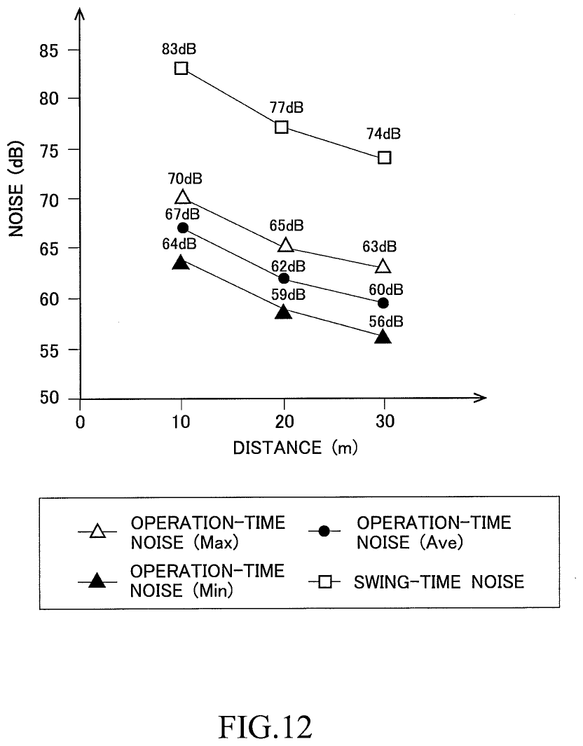

A noise test was performed using the backhoe in which the adhesion suppressing members 10 were bonded to the inner surface of the bucket. In the noise test, “operation-time noise” and “swing-time noise” were measured. The measurement was performed at three spots in total, specifically, spots away from the backhoe by about 10 m, about 20 m, and about 30 m. Here, the “operation-time noise” was noise caused when a series of operations of scooping up heaped swampy soil to the bucket and discharging the heaped swampy soil to another location was performed ten times in total. Further, the “swing-time noise” is noise caused when the bucket was swung to shake out the adhesion residual soil. FIG. 12 shows measurement results of noise.

As shown in FIG. 12, the swing-time noise was 83 dB at the spot of 10 m, 77 dB at the spot of 20 m, and 74 dB at the spot of 30 m. The swing-time noise exceeded 80 dB at the spot of 10 m, and also exceeded 70 dB at the spot of 20 m and the spot of 30 m. It was hence confirmed that, when the bucket was swung, extremely large noise was generated.

The maximum value of the operation-time noise was 70 dB at the spot of 10 m, 65 dB at the spot of 20 m, and 63 dB at the spot of 30 m. The minimum value of the operation-time noise was 64 dB at the spot of 10 m, 59 dB at the spot of 20 m, and 56 dB at the spot of 30 m. The average value of the operation-time noise was 67 dB at the spot of 10 m, 62 dB at the spot of 20 m, and 60 dB at the spot of 30 m. It was confirmed that the operation-time noise was smaller than the swing-time noise by from about 11 dB to about 13 dB (about 12 dB in average) even in a case of the maximum value, and further, the maximum value was 70 dB or less even at the spot of 10 m.

From the results described above, it could be confirmed that, when the adhesion suppressing members 10 of this embodiment were bonded to the bucket of the backhoe, and excavation work was performed, swing of the bucket for shaking out the adhesion residual soil was almost unnecessary or the number thereof could be extremely reduced so that the noise level could be reliably suppressed to be low, thereby being capable of attaining a construction in consideration of the surrounding environment.

The present disclosure is not limited to the above-mentioned embodiment, and can be appropriately modified without departing from the gist of the present disclosure.

### Modification Example 1 of First Embodiment

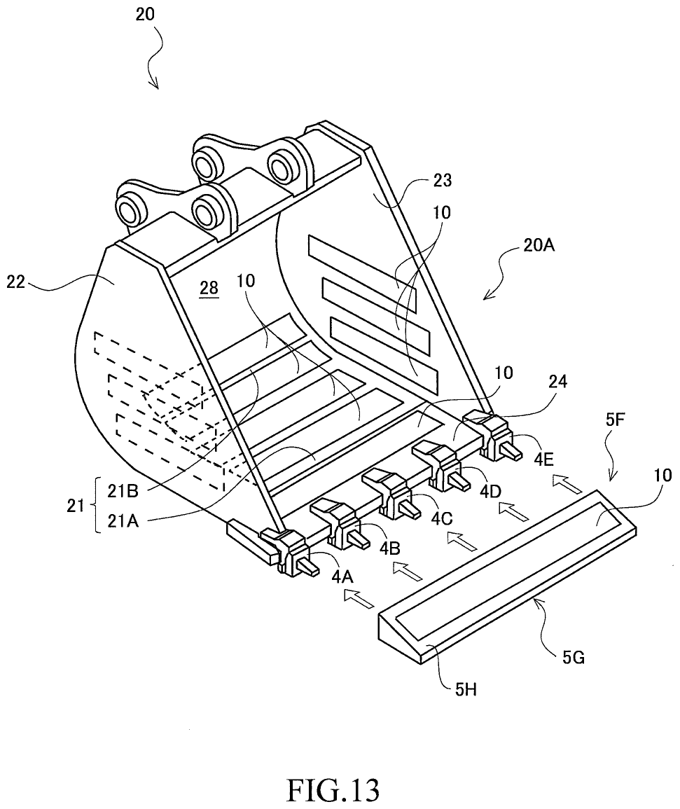

FIG. 13 is a schematic exploded perspective view for illustrating a claw member 5F of Modification Example 1 according to the first embodiment. The claw member 5F of Modification Example 1 is obtained by integrating the claw portions 5A to 5E (see FIG. 2 or the like) described above. Specifically, the claw member 5F includes a claw main body portion 5G having a substantially triangular shape in cross section. It is preferred that the claw portion main body 5G be formed to have a length substantially equal to the opening width of the accommodating portion 28 or the length of the edge plate portion 24. The claw main body portion 5G has a flat surface portion 5H having a flat shape for bonding the adhesion suppressing member 10. On the back side of the claw main body portion 5G, recessed portions (not shown) into which protruding portions of adaptors 4A to 4E are inserted are formed. The claw main body portion 5G is fixed to the adaptors 4A to 4E through intermediation of pins (not shown) or the like.

According to the claw member 5F of Modification Example 1, the claw main body portion 5G is formed not as a separation type in which the claw main body portion 5G is mounted individually to each of the adaptors 4A to 4E but as an integrated type in which the claw main body portion 5G is mounted to the adaptors 4A to 4E collectively. The claw main body portion 5G has the flat surface portion 5H for allowing the adhesion suppressing member 10 to be bonded thereto, and is configured to be capable of reliably improving the adhesive force of the adhesion suppressing member 10 with respect to the claw member 5F. With this, the adhesion suppressing member 10 can be effectively prevented from being peeled off from the claw member 5F due to an impact or the like at the time of excavation work. Further, adhesion of soil on the claw member 5F can be effectively suppressed, thereby also being capable of reliably preventing a decrease in work efficiency.

### Modification Example 2 of First Embodiment

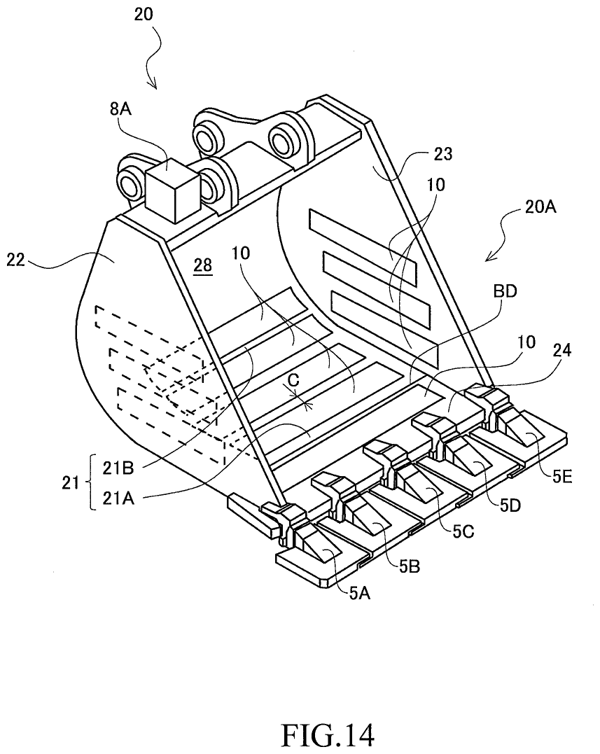

FIG. 14 is a schematic perspective view for illustrating a bucket 20 of Modification Example 2 according to the first embodiment. The bucket 20 of Modification Example 2 includes a vibration generating machine 8A capable of transmitting vibration to the bucket 20. The vibration generating machine 8A may be a vibration generating machine of electric type having a vibration generating motor (not shown) built therein, or a vibration generating machine of fluid-pressure type having a fluid pressure cylinder (not shown) built therein. When the vibration generating machine 8A is of electric type, it is only required that power be supplied from a battery mounted in the backhoe 100. When the vibration generating machine 8A is of fluid-pressure type, it is only required that a fluid pressure be supplied from a hydraulic circuit or the like included in the backhoe 100. A location at which the vibration generating machine 8A is provided is not particularly limited, and it is only required that the vibration generating machine 8A be installed at a location at which the bucket 20 is not embedded in soil at the time of excavation, for example, at the bracket fixing plate portion 25 or the like.

Also in Modification Example 2, the adhesion suppressing members 10 are bonded to the inner surface of the bucket 20. Thus, the vibration generating machine 8A is not required to apply large vibration to the bucket 20, and is only required to apply vibration large enough to attenuate the adhesive force between the front surface of the adhesion suppressing member 10 and the soil. According to Modification Example 2, vibration is applied from the vibration generating machine 8A to the bucket 20, thereby being capable of reliably attenuating the adhesive force of the soil with respect to the front surface of the adhesion suppressing member 10. With this, it is possible to effectively prevent the excavated soil from adhering to the inside of the bucket 20 and depositing thereon, thereby being capable of reliably preventing the decrease in the work efficiency. Further, the vibration generating machine 8A is not required to transmit large vibration, thereby also being capable of effectively suppressing noise.

### Modification Example 3 of First Embodiment

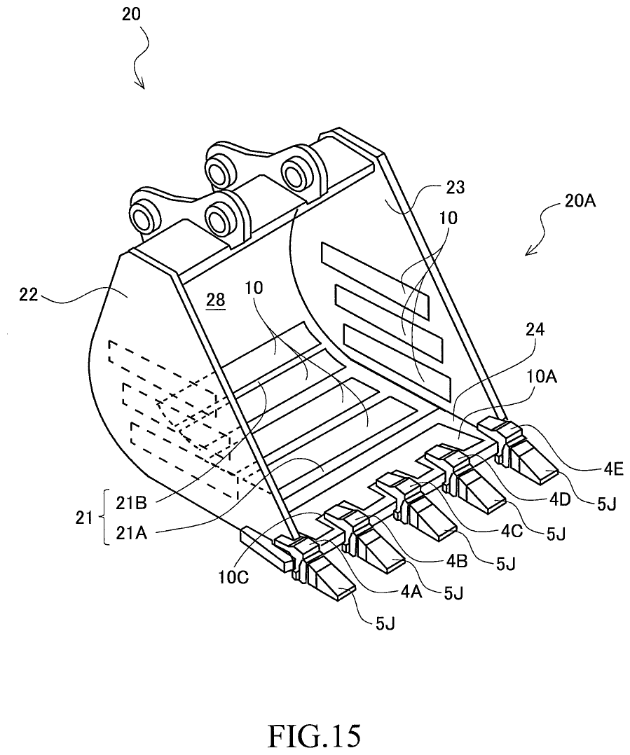

FIG. 15 is a schematic perspective view for illustrating an adhesion suppressing member 10A of Modification Example 3 according to the first embodiment. A bucket 20 of Modification Example 3 includes drilling claws 5J each thinned toward the distal end. When the bucket 20 includes the drilling claws 5J, soil does not deposit between the drilling claws 5J, and is liable to adhere and deposit between the adaptors 4A to 4E. Thus, in the adhesion suppressing member 10A of Modification Example 3, slits 10C each having a substantially U shape are provided at positions corresponding to the adaptors 4A to 4E. It is only required that the slits 10C be formed, for example, by cutting the end portion of the adhesion suppressing member 10 with an electric saw or the like.

According to Modification Example 3, the adhesion suppressing member 10A is provided between the adaptors 4A to 4E of the edge plate portion 24, thereby being capable of effectively suppressing soil from adhering and depositing between the adaptors 4A to 4E. Further, the adhesion suppressing member 10A can be closely bonded to the edge plate portion 24, thereby also being capable of effectively preventing peeling off of the adhesion suppressing member 10A.

### Modification Example 4 of First Embodiment

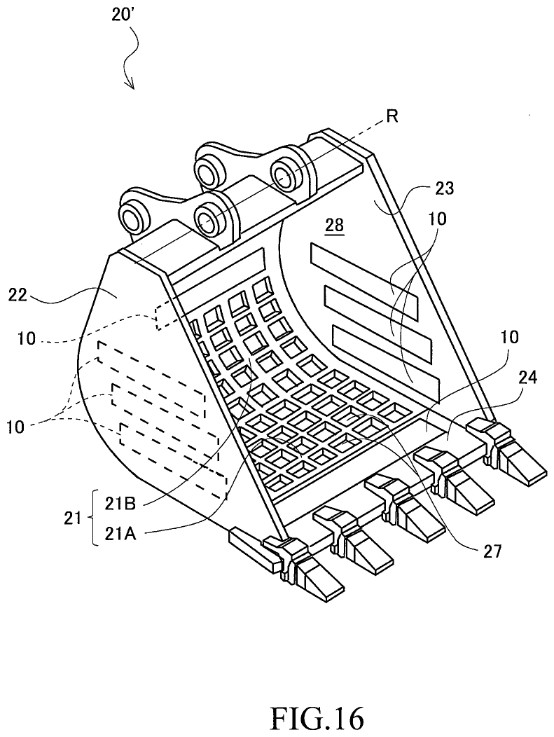

FIG. 16 is a schematic perspective view for illustrating a work tool of Modification Example 4 according to the first embodiment. The work tool of Modification Example 4 is a so-called skeleton bucket 20′ to be used for surface layer improvement work, sludge improvement work, or the like. The skeleton bucket 20′ is obtained by forming a plurality of grids 27 on the flat surface portion 21A and the curved surface portion 21B of the bottom plate portion 21. The skeleton bucket 20′ can sieve soil and sand, stone, and the like by dropping the soil and sand from soil and stone and the like accommodated in the accommodating portion 28 by excavation, through the grids 27. The side plate portions 22 and 23, the edge plate portion 24, the bracket fixing plate portion 25, and the like have substantially similar configurations to that of the general bucket 20 described above, and hence description thereof is omitted.

Also in Modification Example 4, the adhesion suppressing members 10 are bonded to the inner surface of the skeleton bucket 20′. Specifically, the adhesion suppressing members 10 are bonded to the side plate portions 22 and 23, the edge plate portion 24, and a portion of the bottom plate portion 21 on which the grids 27 are not provided (in the illustrated example, a portion of the curved surface portion 21B on the bracket fixing plate portion 25 side). Similarly to the first embodiment, it is only required that the adhesion suppressing members 10 be bonded using a double-sided tape or an adhesive. In the installation of the adhesion suppressing members 10, the adhesion suppressing members 10 may be fixed by spot welding or may be fixed using rivets or bolts.

The adhesion suppressing members 10 for the edge plate portion 24 and the bottom plate portion 21 (curved surface portion 21B) are bonded such that the longitudinal direction is substantially parallel to the rotation axis R direction of the bucket 20′. In the illustrated example, one adhesion suppressing member 10 is bonded to each of the edge plate portion 24 and the bottom plate portion 21. However, the number of adhesion suppressing members 10 is not limited thereto, and it is only required that an appropriate number of adhesion suppressing members 10 in accordance with specific dimensions of each of the edge plate portion 24 and the bottom plate portion 21 be bonded. The adhesion suppressing members 10 for the side plate portions 22 and 23 are bonded such that the longitudinal direction is substantially parallel to the plane direction of the flat surface portion 21A. In the illustrated example, three adhesion suppressing members 10 are bonded to each of the left side plate portion 22 and the right side plate portion 23. However, the number of adhesion suppressing members 10 is not limited thereto, and it is only required that an appropriate number of adhesion suppressing members 10 in accordance with specific dimensions of each of the side plate portions 22 and 23 be bonded.

As described above, the adhesion suppressing members 10 are bonded to the inner surface of the skeleton bucket 20′, thereby being capable of effectively preventing the soil and sand sieved from the soil and stone and the like from adhering to the side plate portions 22 and 23, the edge plate portion 24, or the like, and depositing thereon. That is, it is possible to efficiently separate the soil and sand, stone, and the like from the excavated soil and stone, thereby being capable of reliably improving the work efficiency. Further, the soil and sand and stone can be sieved without largely swinging the skeleton bucket 20′, thereby being capable of effectively suppressing noise caused by swing. Further, the need for a worker to approach the skeleton bucket 20′ for cleaning is also reduced, thereby also being capable of improving safety.

### Second Embodiment

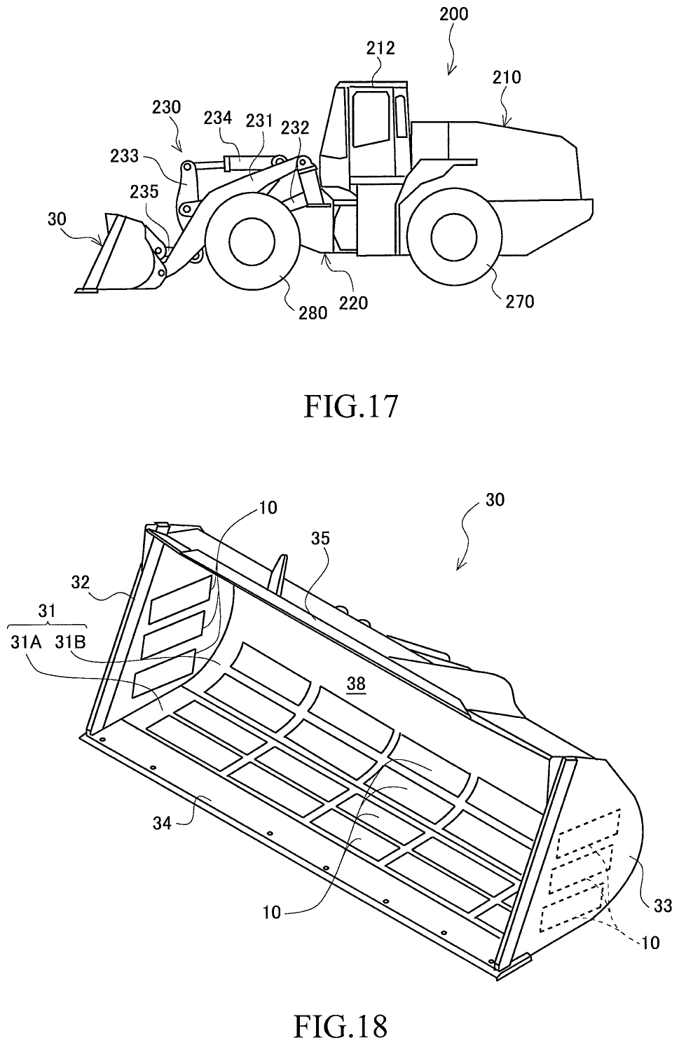

FIG. 17 is a schematic side view for illustrating a construction machinery of a second embodiment. The construction machinery of the second embodiment is, for example, a wheel loader 200 including a bucket 30 as a work tool. The wheel loader 200 includes a rear vehicle body 210 having a rear wheel 270 mounted thereto, a front frame 220 having a front wheel 280 mounted thereto, and an operating machine 230. The rear vehicle body 210 and the front frame 220 have an articulate structure of being swingably connected to each other. In the rear vehicle body 210, an operation room 212 is provided. In the front frame 220, the operating machine 230 is provided.

The operating machine 230 includes a boom 231 having a base end portion swingably mounted to the front frame 220, and a bucket 30 swingably mounted to a distal end portion of the boom 231. The front frame 220 and the boom 231 are coupled to each other by a boom cylinder 232. When the boom cylinder 232 is expanded and contracted, the boom 231 swings, that is, the distal end side of the boom 231 moves vertically. Further, the operating machine 230 includes a tilt arm 233 swingably mounted to the boom 231, a tilt cylinder 234 that couples the front frame 220 and the base end portion of the tilt arm 233 to each other, and a tilt rod 235 that couples the distal end portion of the tilt arm 233 and the bucket 30 to each other. When the tilt cylinder 234 is expanded and contracted, the bucket 30 is tilted. The wheel loader 200 adjusts the position or the inclined posture of the bucket 30 by appropriately combining the vertical movement of the boom 231, the tilting of the bucket 30, and forward movement or backward movement of the wheel loader 200 with each other to perform loading work or carrying work of soil and sand, mud, snow, or the like.

FIG. 18 is a schematic perspective view for illustrating the bucket 30 according to the second embodiment. The bucket 30 is formed of, for example, a steel material, and is formed to be longer in the left-and-right direction than the bucket 20 (see FIG. 2) used in the backhoe 100 described above or the like. Specifically, the bucket 30 includes a bottom plate portion 31, a left side plate portion 32, a right side plate portion 33, a cutting edge 34, and a spill guard 35. The bottom plate portion 31 and the side plate portions 32 and 33 form an accommodating portion 38 for accommodating work pieces, such as soil and sand, mud, or snow.

The bottom plate portion 31 includes a flat surface portion 31A extending from the opening side of the accommodating portion 38 in a substantially planar state, and a curved surface portion 31B that curves from an end portion of the flat surface portion 31A so as to be convex toward an outer side of the accommodating portion 38. The cutting edge 34 is fixed to an end portion of the flat surface portion 31A on a side opposite to the curved surface portion 31B. The spill guard 35 is fixed to an end portion of the curved surface portion 31B on a side opposite to the flat surface portion 31A. A bracket or the like that is coupled to the boom 231 or the tilt rod 234 (both are illustrated in FIG. 17) with a pin is provided to the outer peripheral surface of the curved surface portion 31B. The left side plate portion 32 is fixed to the left end portion of the bottom plate portion 31 so as to close a left opening of the bottom plate portion 31, by welding or the like. The right side plate portion 33 is fixed to the right end portion of the bottom plate portion 31 so as to close a right opening of the bottom plate portion 31, by welding or the like.

Also in the second embodiment, the adhesion suppressing members 10 are installed on the inner surface of the bucket 30. Specifically, the adhesion suppressing members 10 are installed on the bottom plate portion 31 (the flat surface portion 31A and the curved surface portion 31B) and the side plate portions 32 and 33. The adhesion suppressing members 10 may be installed using a double-sided tape or an adhesive or may be fixed by spot welding or the like. The adhesion suppressing members 10 for the bottom plate portion 31 are bonded such that the longitudinal direction is substantially parallel to the width direction of the bucket 30. In the illustrated example, the adhesion suppressing members 10 are bonded to the bottom plate portion 31 in four rows, but the number of rows of the adhesion suppressing members 10 is not limited thereto, and it is only required that an appropriate number of rows of adhesion suppressing members 10 in accordance with specific dimensions of the bottom plate portion 31 be bonded. The adhesion suppressing members 10 for the side plate portions 32 and 33 are bonded such that the longitudinal direction is substantially parallel to the plane direction of the flat surface portion 31A. In the illustrated example, three adhesion suppressing members 10 are bonded to each of the left side plate portion 32 and the right side plate portion 33, but the number of adhesion suppressing members 10 is not limited thereto, and it is only required that an appropriate number of adhesion suppressing members 10 in accordance with specific dimensions of each of the side plate portions 32 and 33 be bonded.

As described above, the adhesion suppressing members 10 are bonded to the inner surface of the bucket 30 used for the wheel loader 200, thereby being capable of effectively suppressing work pieces, such as soil and sand, mud, or snow, from adhering to the inner surface of the bucket 30 and depositing thereon. That is, when the work pieces are loaded from the bucket 30 to a cargo bed of a truck, or the like, or when the work pieces are carried to a predetermined position and released from the bucket 30, the work pieces can be effectively prevented from remaining inside the bucket 30. With this, the work efficiency can be reliably improved. Further, the work pieces can be efficiently released from the bucket 30 without largely swinging the bucket 30, thereby also being capable of effectively suppressing occurrence of noise or vibration caused by swing. Further, the need for a worker to approach the bucket 30 for cleaning is also reduced, thereby also being capable of improving safety.

Although description with reference to the drawings is omitted, as a bucket that can be mounted to the wheel loader 200, a skeleton bucket as illustrated in FIG. 16 is given. The adhesion suppressing member 10 of the present disclosure can also be applied to the skeleton bucket for the wheel loader 200 as described above. Also in this case, it is only required that the adhesion suppressing members 10 be installed at the side plate portions and a portion of the bottom plate portion on which grids are not provided, of the skeleton bucket.

### Third Embodiment

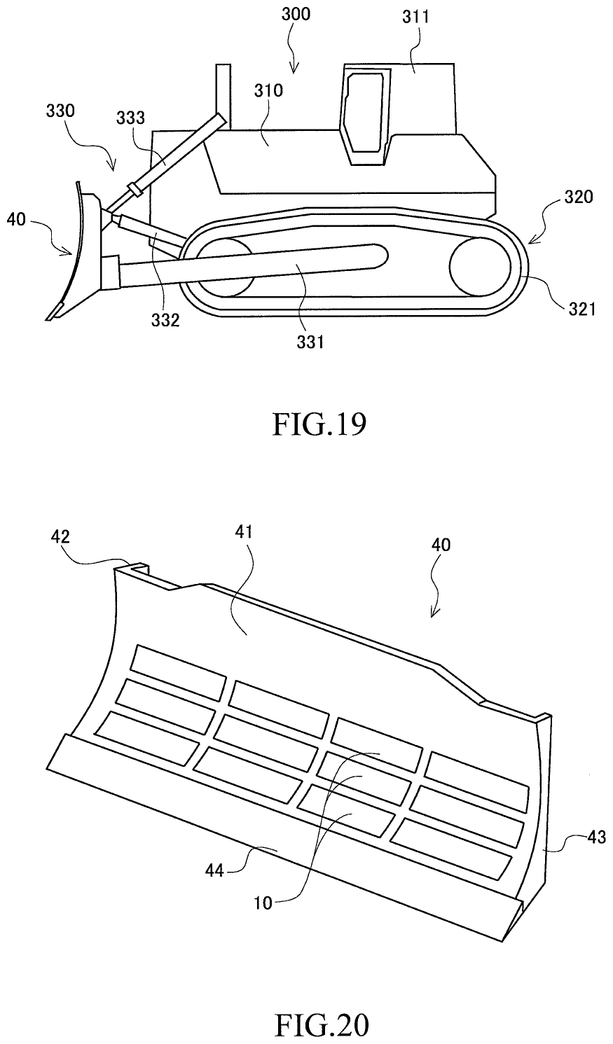

FIG. 19 is a schematic side view for illustrating a construction machinery of a third embodiment. The construction machinery of the third embodiment is a bulldozer 300 to be used for, for example, excavation or carrying of soil and sand or leveling in embankment work, reclamation work, or the like. The bulldozer 300 includes a vehicle body frame 310, a pair of left and right traveling machines 320, and an operating machine 330. An operation room 311 is provided above the vehicle body frame 310. The traveling machine 320 includes an endless crawler belt 321 that enables traveling on an irregular ground or the like. The traveling machines 320 are provided at left and right lower portions of the vehicle body frame 310, respectively.

The operating machine 330 includes a blade (soil removal plate) 40 as a work tool, support frames 331 and 332, and a raising and lowering cylinder 333. The support frames 331 and 332 have base end portions swingably attached to the traveling machine 320 or the vehicle body frame 310. The blade 40 is attached to the distal end portions of the support frames 331 and 332, and pushes out soil and sand, mud, or the like. The raising and lowering cylinder 333 has a base end portion attached to the vehicle body frame 310. The blade 40 is mounted to the distal end portion of the raising and lowering cylinder 333, and when the raising and lowering cylinder 333 expands and contracts, the blade 40 raises and lowers vertically.

FIG. 20 is a schematic perspective view for illustrating the blade 40 according to the third embodiment. The blade 40 is formed of, for example, a steel material or the like, and includes a blade main body plate 41 that curves so as to be convex rearward, a pair of side plates 42 and 43 joined to both left and right ends of the blade main body plate 41, respectively, and a cutting edge 44 fixed to the lower end of the blade main body plate 41. Brackets (not shown) or the like to which the support frames 331 and 332 and the raising and lowering cylinder 333 (both are illustrated in FIG. 19) described above are coupled are provided to the rear surface of the blade main body plate 41.

Also in the third embodiment, the adhesion suppressing members 10 are installed on a front face of the blade main body plate 41 of the blade 40. Specifically, the adhesion suppressing members 10 are installed such that the longitudinal direction is substantially parallel to the width direction of the blade main body plate 41. The plurality of adhesion suppressing members 10 may be installed so as to be bedded entirely on the front face of the blade main body plate 41, but it is preferred that the plurality of adhesion suppressing members 10 be installed at a predetermined clearance vertically and horizontally. The installation of the adhesion suppressing members 10 is not particularly limited, but it is preferred that the adhesion suppressing members 10 be fixed by spot welding.

As described above, the adhesion suppressing members 10 are installed on the front face of the blade main body plate 41, thereby being capable of effectively suppressing the work pieces, such as soil and sand, mud, or the like, from adhering to the front face of the blade main body plate 41 and depositing thereon. That is, the efficiency of the dozing work or the excavation work can be reliably improved. Further, the operation of vertically moving the blade 40 to shake out adhesion soil or the like is almost unnecessary or the number thereof can be extremely reduced, thereby also being capable of effectively suppressing occurrence of noise or vibration. Further, the need for a worker to approach the blade 40 for cleaning is reduced, thereby also being capable of improving safety.

### Fourth Embodiment

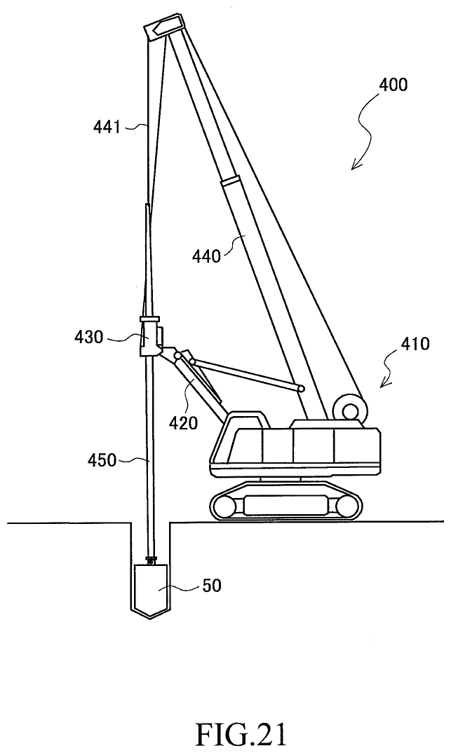

FIG. 21 is a schematic side view for illustrating a construction machinery of a fourth embodiment. The construction machinery of the fourth embodiment is an earth drill excavator 400 to be used in an earth drill method of cast-in-place pile work. The earth drill excavator 400 includes a drilling bucket 50 as a work tool. In the earth drill method, an operation of rotating the drilling bucket 50, taking the excavated soil and sand in the drilling bucket 50 while excavating the ground, and discharging the taken-in soil and sand to the ground is repeatedly performed to excavate an excavation hole to a desired depth.

The earth drill excavator 400 includes a lifting machine 410 such as a crane, a rotary drive 430 mounted to a front frame 420 of the lifting machine 410, and a kelly bar 450 suspended form a boom 440 of the lifting machine 410 by a wire 441. The drilling bucket 50 is mounted to the distal end of the kelly bar 450, and a rotation force of the rotary drive 430 is transmitted via the kelly bar 450.

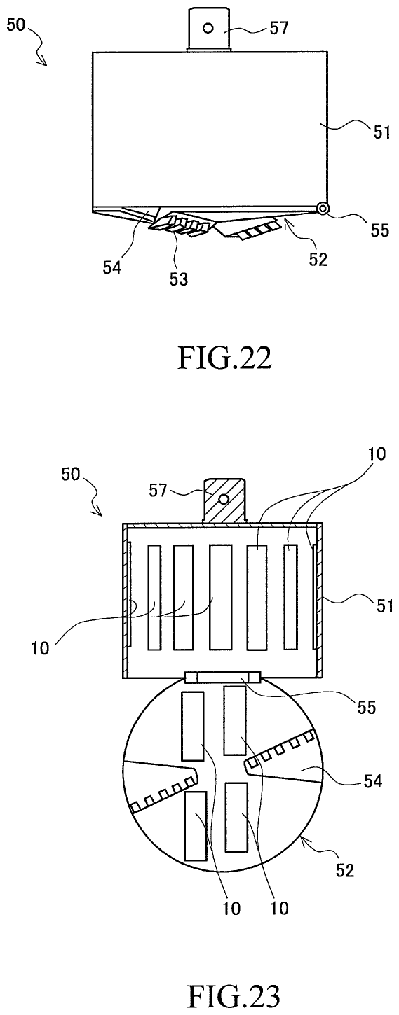

FIG. 22 is a schematic side view for illustrating the drilling bucket 50 according to the fourth embodiment. FIG. 23 is a schematic longitudinal sectional view for illustrating the drilling bucket 50 according to the fourth embodiment. The drilling bucket 50 includes a bucket main body 51 having a cylindrical shape, and a bottom lid 52 having a disk shape that is capable of closing a lower end opening of the bucket main body 51. The bucket main body 51 and the bottom lid 52 are each formed of, for example, a steel material or the like. A socket 57 is provided on the upper end of the bucket main body 51. A distal end of the kelly bar 450 (illustrated in FIG. 21) described above is coupled to the socket 57 by a pin or the like.

The bottom lid 52 is openably and closably mounted to the lower end edge of the bucket main body 51 through intermediation of a hinge mechanism 55. The bottom lid 52 closes the lower end opening of the bucket main body 51 (a closed state of which is illustrated in FIG. 22) at the time of excavating the ground. A plurality of bits 53 for excavating the ground are provided on the lower surface of the bottom lid 52. Further, the bottom lid 52 has a slit 54 for taking the excavated soil and sand into the bucket main body 51. The excavated soil and sand taken in the bucket main body 51 is discharged onto the ground by opening the bottom lid 52 (an open state of which is illustrated in FIG. 23).

As illustrated in FIG. 23, the adhesion suppressing members 10 are installed on the inner peripheral surface of the bucket main body 51 and the inner surface of the bottom lid 52 (in the closed state of the bottom lid 52, the surface facing the internal space of the bucket main body 51). Specifically, the adhesion suppressing members 10 for the bucket main body 51 are installed such that the longitudinal direction is substantially parallel to the axial direction (vertically downward direction) of the bucket main body 51. The number of adhesion suppressing members 10 is not particularly limited, but it is desired that four or more adhesion suppressing members 10 be installed at an equal pitch in the circumferential direction. The plurality of adhesion suppressing members 10 may be installed so as to be bedded on the inner peripheral surface of the bucket main body 51, but it is preferred that the adhesion suppressing members 10 be installed at a predetermined clearance in the circumferential direction. The adhesion suppressing members 10 for the bottom lid 52 are installed such that the longitudinal direction is directed to the substantially vertical direction under a state in which the bottom lid 52 is opened. The method of fixing the adhesion suppressing members 10 is not particularly limited, but it is desired that the adhesion suppressing members 10 be fixed by spot welding.

As described above, the adhesion suppressing members 10 are installed on the inner peripheral surface of the bucket main body 51 and the inner surface of the bottom lid 52, thereby being capable of effectively suppressing the excavated soil and sand taken in the bucket main body 51 from adhering to the inner peripheral surface of the bucket main body 51 or the inner surface of the bottom lid 52 and depositing thereon. That is, the excavated soil and sand can be effectively prevented from remaining inside the drilling bucket 50 when the excavated soil and sand is to be discharged onto the ground. With this, the work period of the pile work can be shortened while reliably improving the work efficiency. Further, the operation of applying an impact to the drilling bucket 50 so as to shake out the adhesion residual soil from the inside of the drilling bucket 50 is almost unnecessary or the number thereof can be extremely reduced, thereby also being capable of effectively preventing occurrence of large noise or vibration. Further, the need for a worker to approach the drilling bucket 50 for cleaning is also reduced, thereby also being capable of improving safety.

### Fifth Embodiment

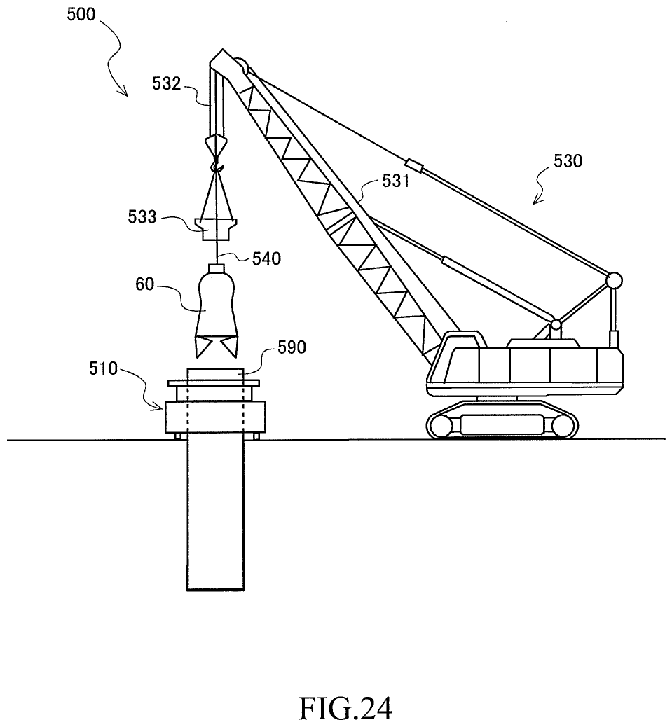

FIG. 24 is a schematic side view for illustrating a construction machinery of a fifth embodiment. The construction machinery of the fifth embodiment is an all-casing excavator 500 to be used in an all-casing method of cast-in-place pile work. The all-casing excavator 500 includes a hammer grab 60 as a work tool. In the all-casing method, an operation of press-fitting a casing tube 590 into the ground while rotating or swinging the casing tube 590, and discharging the soil and sand inside the casing tube 590 onto the ground by the hammer grab 60 is repeated while additionally providing the casing tube 590 to excavate the excavation hole to a desired depth.

The all-casing excavator 500 includes a tubing machine 510 and a lifting machine 530 such as a crane. The tubing machine 510 is press-fitted into the ground by rotating or swinging the casing tube 590. A cutter bit (not shown) is provided to the distal end of the casing tube 590. The lifting machine 530 includes a jib 531. A crown 533 that disengageably holds the hammer grab 60 is mounted to a distal end of a suspension wire 532 hung from the jib 531. The hammer grab 60 is suspended from the lifting machine 530 so as to be capable of performing a raising and lowering operation through intermediation of a raising and lowering operation wire 540 inserted through a center portion of the crown 533.

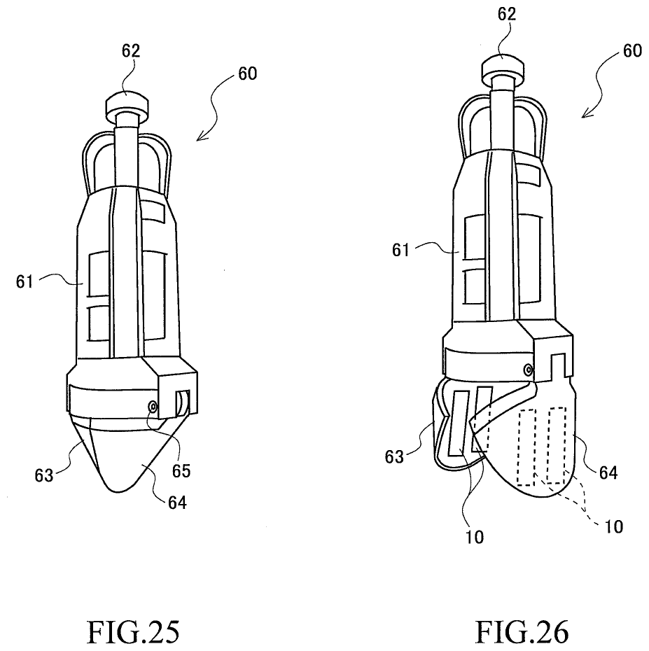

FIG. 25 is a schematic perspective view for illustrating a state in which the hammer grab 60 according to the fifth embodiment is closed. FIG. 26 is a schematic perspective view for illustrating a state in which the hammer grab 60 according to the fifth embodiment is opened. The hammer grab 60 includes a hammer grab main body 61, a slide block 62 provided above the hammer grab main body 61, and a pair of shells 63 and 64 openably and closably mounted to the lower end portion of the hammer grab main body 61 through intermediation of a hinge mechanism 65. Each of the shells 63 and 64 is formed in a substantially semi-circular cone shape, and the shells 63 and 64 are held in contact with each other under the closed state to grab the excavated soil and sand.

When the excavation work is to be performed, the raising and lowering operation wire 540 (illustrated in FIG. 24) is fed, and the slide block 62 is separated from the crown 533 (illustrated in FIG. 24). When the slide block 62 is separated, the hammer grab 60 drops toward the ground, and bites into the ground under a state in which the shells 63 and 64 are opened. After that, when the raising and lowering operation wire 540 is wound up, the shells 63 and 64 are closed to grab the excavated soil and sand. Under this state, the hammer grab 60 is pulled up to lock the slide block 62 to the crown 533. At the time of discharging the excavated soil and sand to the ground, when the raising and lowering operation wire 540 is loosened, the shells 63 and 64 are brought into an open state by a biasing force of a spring (not shown).

As illustrated in FIG. 26, the adhesion suppressing members 10 are installed on the inner peripheral surface of each of the shells 63 and 64. Specifically, the adhesion suppressing members 10 are installed such that the longitudinal direction is directed to the substantially vertical direction under a state in which the shells 63 and 64 are opened. The method of fixing the adhesion suppressing members 10 is not particularly limited, but it is desired that the adhesion suppressing members 10 be fixed by spot welding. The number of adhesion suppressing members 10 is not particularly limited, but it is desired that at least two or more adhesion suppressing members 10 be installed on each of the shells 63 and 64.

As described above, the adhesion suppressing members 10 are installed on the inner peripheral surface of each of the shells 63 and 64, thereby being capable of effectively suppressing the excavated soil and sand grabbed by the shells 63 and 64 from adhering to the inner peripheral surface of each of the shells 63 and 64 and depositing thereon. That is, when the excavated soil and sand is to be discharged onto the ground, the excavated soil and sand can be effectively prevented from remaining on the inner peripheral surface of each of the shells 63 and 64. With this, the work period of the pile work can also be shortened while reliably improving the work efficiency. Further, the operation of applying an impact to the hammer grab 60 so as to shake out the adhesion residual soil from each of the shells 63 and 64 is almost unnecessary or the number thereof can be extremely reduced, thereby also being capable of effectively suppressing occurrence of large noise or vibration. Further, the need for a worker to approach the hammer grab 60 for cleaning is also reduced, thereby also being capable of improving safety.

### Sixth Embodiment

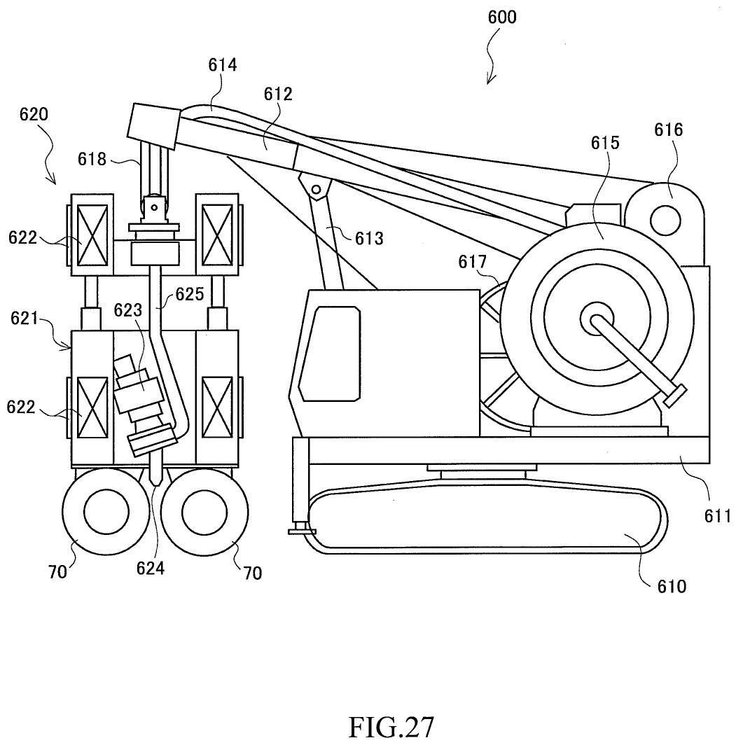

FIG. 27 is a schematic side view for illustrating a construction machinery of a sixth embodiment. The construction machinery of the sixth embodiment is a horizontal multi-shaft digging machine 600 to be used in an underground continuous wall construction method. The horizontal multi-shaft digging machine 600 includes a digging unit 620 including a rotary cutter 70 as a work tool. In the underground continuous wall construction method, the rotary cutter 70 is rotationally driven under a state in which the excavator 620 is suspended in a groove filled with a stable liquid, and accordingly, the ground is dug down to the vertically lower side. The excavated soil and sand is sucked up onto the ground together with the stable liquid, is subjected to processing such as soil and sand separation, then is returned into the groove again, and is circulated and used.

The horizontal multi-shaft digging machine 600 includes a crawler-type lower traveling body 610, a pedestal 611 mounted to an upper portion of the lower traveling body 610 so as to be capable of freely turning, and an expansion and contraction boom 612 provided on the pedestal 611 so as to be freely erectable. The expansion and contraction boom 612 erects by an erection jack 613. The digging unit 620 is suspended from the distal end of the expansion and contraction boom 612 so as to freely raise and lower through intermediation of the wire 618. Further, on the pedestal 611, there are provided a sludge-pumping hose reel 615 that winds up the sludge-pumping hose 614, a winch 616 that raises and lowers the digging unit 620 by the wire 618, a hydraulic pressure hose reel 617 that winds up a hydraulic pressure hose, a cable reel (not shown) that winds up a measurement cable, and the like.

The digging unit 620 includes a digging unit main body 621. On the digging unit main body 621, there are provided a plurality of posture holding plates 622 that come into abutment against the inner peripheral surface of the groove to hold the posture of the digging unit main body 621. Further, at the lower end of the digging unit main body 621, a pair of rotary cutters 70 of hydraulic driving type are arranged side by side. A sludge-pumping pump 623 is provided at the substantially center of the digging unit main body 621. The sludge-pumping pump 623 sucks the excavated soil and sand and the stable liquid from a suction port 624 arranged between the rotary cutters 70 and 70. The excavated soil and sand and the stable liquid sucked from the suction port 624 are pumped to the sludge-pumping hose reel 615 through a sludge-pumping pipe 625 and the sludge-pumping hose 614. The excavated soil and sand and the stable liquid pumped to the sludge-pumping hose reel 615 are sent from a discharge port 619 to a mud water treatment plant (not shown) to be treated.

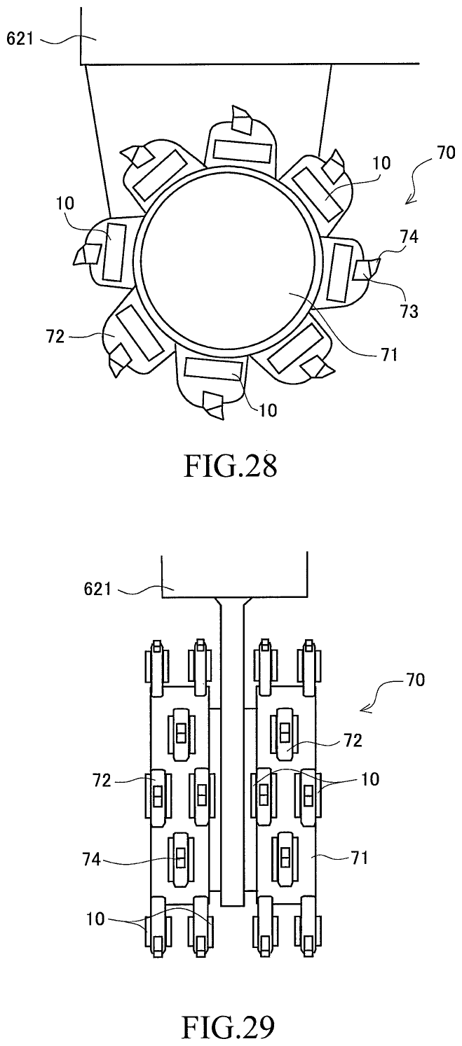

FIG. 28 is a schematic view of the rotary cutter 70 according to the sixth embodiment as viewed from the rotation axis direction. FIG. 29 is a schematic view of the rotary cutter 70 according to the sixth embodiment as viewed from the radial direction. The rotary cutter 70 includes a rotary drum 71 having a cylindrical shape, blades 72 having a substantially trapezoidal plate shape which are provided on the outer peripheral surface of the rotary drum 71 so as to protrude in the radial direction, and cutter bits 74 fixed to the distal ends of the blades 72 through intermediation of holders 73. The plurality of blades 72 are provided on the outer peripheral surface of the rotary drum 71 at a predetermined pitch in the circumferential direction.

Here, adhesion and deposition of the excavated soil and sand on the blade 72 of the rotary cutter 70 result in causing stagnation of the created mixed soil on the lower portion of the digging unit main body 621 to significantly degrade the excavation speed. In the sixth embodiment, the adhesion suppressing member 10 is installed on the front surface of the blade 72 of the rotary cutter 70. Specifically, the adhesion suppressing members 10 are installed on a surface of the blade 72 facing the digging unit main body 621 (hereinafter, “inner surface”), and a surface of the blade 72 on a side opposite to the digging unit main body 621 (hereinafter, “outer surface”). The adhesion suppressing members 10 are installed such that the longitudinal direction is substantially parallel to a tangential direction of the rotary drum 71. The method of fixing the adhesion suppressing members 10 is not particularly limited, but it is desired that the adhesion suppressing members 10 be fixed by spot welding.

As described above, the adhesion suppressing members 10 are installed on the inner surface and the outer surface of the blade 72 of the rotary cutter 70, thereby being capable of effectively suppressing the excavated soil and sand from adhering to the inner surface and the outer surface of the blade 72 and depositing thereon. That is, the created mixed soil can be effectively prevented from stagnating on the lower portion of the digging unit main body 621 and the degradation of the excavation speed can also be effectively suppressed. With this, a work period of continuous underground wall work can also be shortened while reliably improving the work efficiency. Further, the mixing ratio of the mixed soil and the stable liquid is stabilized, thereby also being capable of improving the construction quality. Further, the need for a worker to approach the rotary cutter 70 for cleaning is also reduced, thereby also being capable of improving safety.

Although description with reference to the drawings is omitted, the adhesion suppressing member 10 is installed not only on the rotary cutter 70, but also on the front surface of the digging unit main body 621, thereby also being capable of improving an adhesion suppression effect of the soil and sand.

### Seventh Embodiment

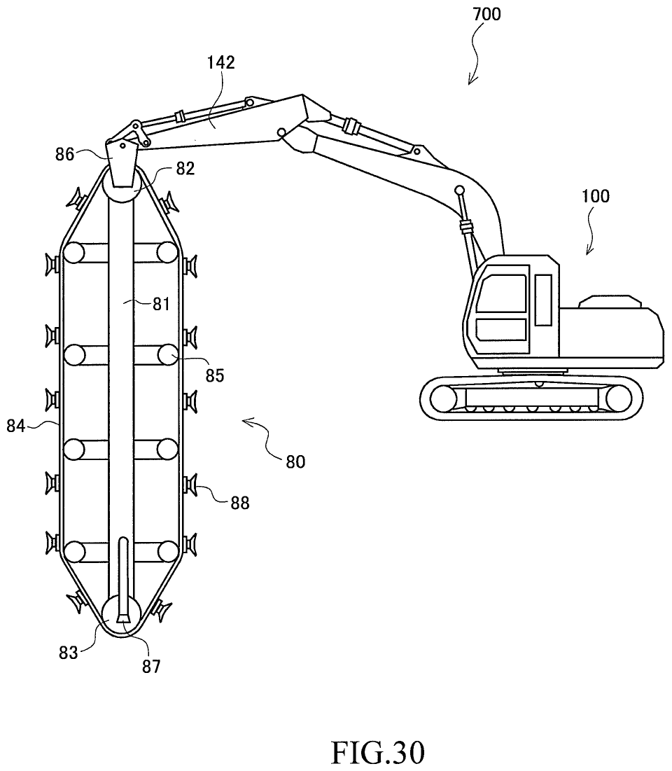

FIG. 30 is a schematic side view for illustrating a construction machinery of the seventh embodiment. The construction machinery of a seventh embodiment is a ground improvement machine 700 to be used in a power blender method of intermediate layer mixing processing work or the like. The ground improvement machine 700 includes a trencher-type stirring mixing machine 80 as a work tool. In the power blender method, an improvement material such as a cement-based solidifying material is ejected from the trencher-type stirring mixing machine 80 to the ground, and excavation of the ground and stirring mixing of the improvement material are performed by stirring blades 88 included in the trencher-type stirring mixing machine 80, thereby continuously creating a stable improved body.

The ground improvement machine 700 includes a backhoe 100 as a base machine. The backhoe 100 basically has the same structure as the configuration illustrated in FIG. 1, and hence detailed description is omitted. The trencher-type stirring mixing machine 80 is mounted to the distal end of the arm 142 of the backhoe 100. Specifically, the trencher-type stirring mixing machine 80 includes a frame 81 having a substantially prismatic shape, a drive sprocket 82 provided to the upper end of the frame 81, a driven sprocket 83 provided to the lower end of the frame 81, an endless drive chain 84 wound around each of the sprockets 82 and 83, a plurality of chain tensioners 85 provided to a frame 81, and a joint 86 provided to the upper end of the frame 81. The joint 86 couples the frame 81 to the distal end of the arm 142 so as to be rotatable about the axis of the longitudinal direction. On a lower end side of the frame 81, a discharge port 87 for ejecting the improvement material is formed. The plurality of stirring blades 88 are provided on the outer periphery of the drive chain 84 at a predetermined pitch.

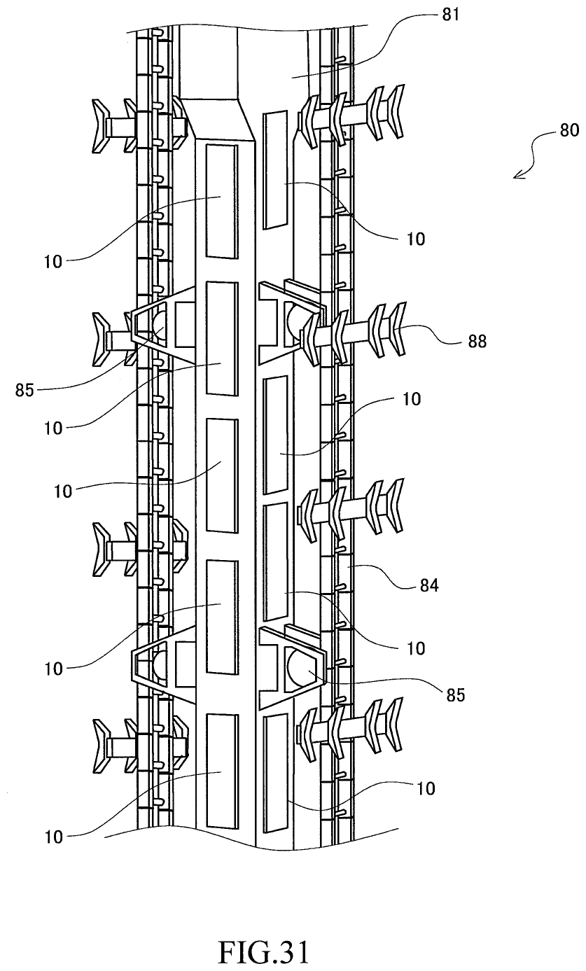

As illustrated in FIG. 31, the adhesion suppressing members 10 are installed on the front surface of the frame 81 of the trencher-type stirring mixing machine 80. Specifically, the adhesion suppressing members 10 are installed on the four surfaces of the frame 81 formed in a prismatic shape such that its longitudinal direction is substantially parallel to the longitudinal direction of the frame 81. The method of fixing the adhesion suppressing members 10 is not particularly limited, but it is desired that the adhesion suppressing members 10 be fixed by spot welding.

As described above, the adhesion suppressing members 10 are entirely installed on the front surface of the frame 81 of the trencher-type stirring mixing machine 80, thereby being capable of effectively suppressing the excavated soil and sand from adhering to the front surface of the frame 81. That is, the excavated soil and sand can be prevented from depositing between the frame 81 and the drive chain 84. With this, excavation of the ground by the stirring blades 88 and stirring and mixing of the improvement material can be efficiently performed, thereby also being capable of improving the construction quality as well as shortening the work period. Further, the need for a worker to approach the trencher-type stirring mixing machine 80 for cleaning is also reduced, thereby also being capable of improving safety.

### Modification Example of Seventh Embodiment

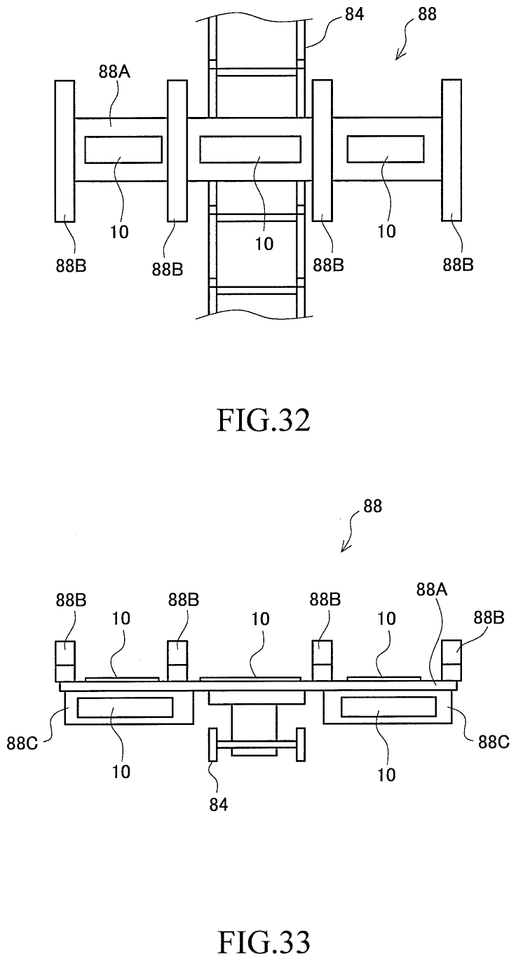

Positions at which the adhesion suppressing members 10 are installed are not limited to the frame 81 of the trencher-type stirring mixing machine 80, but can also be installed on the stirring blades 88. FIG. 32 is a schematic plan view for illustrating the stirring blades 88. FIG. 33 is a schematic side view for illustrating the stirring blade 80. The stirring blade 88 includes a base plate 88A having a long plate shape which is fixed to the outer periphery of the drive chain 84, a plurality of excavation blades 88B fixed to a surface of the base plate 88A on a side opposite to the drive chain 84 (hereinafter, “front surface”), and stirring blades 88C having a long plate shape which are fixed to a surface of the base plate 88A on a side opposite to the excavation blades 88B. The plurality of excavation blades 88B are arranged on the front surface of the base plate 88A at a predetermined interval in the longitudinal direction of the base plate 88A. The stirring blades 88C are provided on the back surface of the base plate 88A at a substantially right angle along the longitudinal direction of the base plate 88A.

In a modification example of the seventh embodiment, the adhesion suppressing members 10 are installed on the front surface of the base plate 88A (between the excavation blades 88B and 88B) and the front surfaces of the stirring blades 88C. As described above, the adhesion suppressing members 10 are installed on the base plate 88A of the stirring blade 88 and the front surface of the stirring blade 88C. Thus, it is possible to effectively suppress the excavated soil and sand from adhering to the stirring blade 80 and depositing thereon, thereby being capable of further improving the work efficiency and the construction quality.

### Others

The adhesion suppressing member 10 can be widely applied to work tools of construction machineries other than the construction machineries of the above-mentioned embodiments. For example, when the adhesion suppressing member 10 of the present disclosure is installed on a blade of a motor grader or an apron of a scraper, an adhesion suppression effect of excavated soil and sand or the like can be obtained.

Further, in the above-mentioned embodiment, as examples of the work pieces for the construction machinery, soil and sand, mud, snow, and the like have been described. However, the physical property of the work pieces may be any of liquid, semisolid, and solid, and similar functions and effects can be exerted even for work pieces having an adhesive property, such as bentonite, concrete, or mortar. Further, the adhesion suppressing member 10 has been described as including the resin material 12 as an upper layer and the metal material 11 as a lower layer, but the lower layer may be formed of a base material other than a metal as long as the material can be bonded to the resin material 12. Further, it is only required that the adhesion suppressing members 10 have such a size that a plurality of adhesion suppressing members 10 can be bonded to the bottom plate portion 21 and the side plate portions 22 and 23 of the bucket 20. Further, the shape of the adhesion suppressing member 10 is also not limited to a rectangular strip shape (oblong plate shape), but may be a circular shape, an elliptical shape, a triangular shape, or a polygonal shape having five or more sides.

### REFERENCE SIGNS LIST

10 adhesion suppressing member
11 metal material
12 resin material
20 bucket
20′ skeleton bucket
20A bucket main body portion
21 bottom plate portion
21A flat surface portion
21B curved surface portion
22 left side plate portion
23 right side plate portion
24 edge plate portion
25 bracket fixing plate portion
27 grid
4A to 4E adaptor
5A to 5E claw portion
6L, 6R bracket
30 bucket
30A bucket main body portion
31 bottom plate portion
31A flat surface portion
31B curved surface portion
32 left side plate portion
33 right side plate portion
40 blade
41 blade main body plate
50 drilling bucket
51 bucket main body
52 bottom lid
60 hammer grab
63, 64 shell
70 rotary cutter
72 blade
80 trencher-type stirring mixing machine
81 frame
88 stirring blade
100 backhoe
142 arm
143 bucket link
150 to 152 cylinder
200 wheel loader
231 boom
300 bulldozer
331, 332 support frame
400 earth drill excavator
450 kelly bar
500 all-casing excavator
530 lifting machine
600 horizontal multi-shaft digging machine
621 digging unit main body
700 ground improvement machine

1. An adhesion suppressing member, which is configured to suppress a work piece from adhering to a work tool of a construction machinery,
wherein the adhesion suppressing member is formed in a plate shape and comprises, on a front surface thereof, a resin material having a water repellent property, and the adhesion suppressing member is installed at a predetermined portion of the work tool such that the front surface forms a part of a surface of the work tool held in contact with the work piece.

2. The adhesion suppressing member according to claim 1, further comprising a metal material having a plate shape, which is bonded to a surface of the resin material on a side opposite to the front surface, and is fixed to the predetermined portion.

3. A work tool comprising the adhesion suppressing member of claim 1,
wherein the construction machinery is a backhoe,
wherein the work tool is a bucket, which is turnably mounted to a distal end of an arm of the backhoe, and which includes a bottom plate portion and a side plate portion forming an accommodating portion that accommodates the excavated work piece, and
wherein the adhesion suppressing member is installed on any one or both of the bottom plate portion and the side plate portion.

4. The work tool according to claim 3,
wherein the bucket is a skeleton bucket in which a plurality of grids are provided to the bottom plate portion, and
wherein the adhesion suppressing member is installed at any one or both of a portion of the bottom plate portion on which the grids are not provided and the side plate portion.

5. The work tool according to claim 3,
wherein the adhesion suppressing member is formed in an oblong plate shape, and
wherein the adhesion suppressing member comprises a plurality of adhesion suppressing members, which are installed in parallel on the bottom plate portion such that a longitudinal direction of each of the plurality of adhesion suppressing members is substantially parallel to a rotation axis direction of the bucket.

6. The work tool according to claim 5,
wherein the bottom plate portion includes a flat surface portion extending from an opening side of the accommodating portion, and a curved surface portion curved from an end portion of the flat surface portion on a side opposite to the opening side so as to be convex toward an outer side of the accommodating portion, and
wherein the adhesion suppressing member comprises a plurality of the adhesion suppressing members, which are installed on the flat surface portion and at least a portion of the curved surface portion on the flat surface portion side.

7. The work tool according to claim 3,
wherein the bucket includes an edge plate portion bonded to an end portion of the bottom plate portion to form a part of an opening edge of the accommodating portion, and
wherein the adhesion suppressing member is installed on at least one or all of the bottom plate portion, the side plate portion, and the edge plate portion.

8. The work tool according to claim 7,
wherein the bucket further includes a claw portion mounted to a distal end of the edge plate portion through intermediation of an adaptor, and
wherein the adhesion suppressing member is installed on at least one or all of the bottom plate portion, the side plate portion, the edge plate portion, and the claw portion.

9. The work tool according to claim 8, further comprising a vibration generating machine that is provided to the bucket and is configured to transmit vibration to the bucket.

10. A work tool comprising the adhesion suppressing member of claim 1,
wherein the construction machinery is a wheel loader,
wherein the work tool is a bucket, which is turnably mounted to a distal end of a boom of the wheel loader, and which includes a bottom plate portion and a side plate portion forming an accommodating portion that accommodates the work piece, and
wherein the adhesion suppressing member is installed on any one or both of the bottom plate portion and the side plate portion.

11. A work tool comprising the adhesion suppressing member of claim 1,
wherein the construction machinery is a bulldozer,
wherein the work tool is a blade, which is mounted to a distal end of a support frame of the bulldozer, and which is configured to push out the work piece, and
wherein the adhesion suppressing member is installed on a front face of the blade.

12. A work tool comprising the adhesion suppressing member of claim 1,
wherein the construction machinery is an earth drill excavator to be used in an earth drill method of pile work,
wherein the work tool is a drilling bucket, which is mounted to a distal end of a kelly bar included in the earth drill excavator, and which is configured to take in excavated soil and sand as the work piece and discharge the excavated soil and sand,
wherein the drilling bucket includes a bucket main body having a cylindrical shape, and a bottom lid configured to close a lower end opening of the bucket main body, and
wherein the adhesion suppressing member is installed on any one or both of an inner peripheral surface of the bucket main body and an inner surface of the bottom lid.

13. A work tool comprising the adhesion suppressing member of claim 1,
wherein the construction machinery is an all-casing excavator to be used in an all-casing method of pile work,
wherein the work tool is a hammer grab, which is suspended from a lifting machine included in the all-casing excavator, and which is configured to grab excavated soil and sand as the work piece and discharge the excavated soil and sand,
wherein the hammer grab includes a hammer grab main body, and a pair of shells openably and closably mounted to a lower end portion of the hammer grab main body, and
wherein the adhesion suppressing member is installed on an inner peripheral surface of each of the pair of shells.

14. A work tool comprising the adhesion suppressing member of claim 1,
wherein the construction machinery is a horizontal multi-shaft digging machine to be used in an underground continuous wall construction method,
wherein the work tool is a pair of rotary cutters, which are arranged side by side at a lower end of a digging unit main body included in the horizontal multi-shaft digging machine, and which are configured to be rotationally driven to dig a ground,
wherein the rotary cutters each include a rotary drum having a cylindrical shape, and a plurality of blades provided on an outer peripheral surface of the rotary drum so as to protrude in a radial direction, each of the plurality of blades having a cutter bit fixed to a distal end of each of the plurality of blades, and
wherein the adhesion suppressing member is installed on a front surface of each of the plurality of blades.

15. A work tool comprising the adhesion suppressing member of claim 1,
wherein the construction machinery is a ground improvement machine to be used in a power blender method,
wherein the work tool is a trencher-type stirring mixing machine included in the ground improvement machine,
wherein the trencher-type stirring mixing machine includes a frame having a columnar shape, sprockets provided to an upper end and a lower end of the frame, respectively, an endless chain wound around each of the sprockets, and a plurality of stirring blades provided on an outer periphery of the endless chain, and
wherein the adhesion suppressing member is installed on any one or both of a front surface of the frame and a front surface of each of the stirring blades.

16. A claw member, which is configured to be mounted to the work tool of claim 7, the claw member comprising a claw main body portion having a flat surface portion formed to have a length substantially equal to an opening width of the bucket,
wherein the claw main body portion is mounted to a distal end of the edge plate portion through intermediation of an adaptor, and the adhesion suppressing member is installed on the flat surface portion.

17. An adhesion suppressing method using the adhesion suppressing member of claim 1, comprising installing the adhesion suppressing member on the predetermined portion of the work tool such that the front surface of the adhesion suppressing member forms a part of the surface of the work tool held in contact with the work piece.
